(19) United States
(12) Patent Application Publication
(10) Pub. No.: US 2026/0259439 A1
(43) Pub. Date: Sep. 3, 2026

(54) LIGHT MODULATOR AND SUBSTRATE HAVING ELECTRODES COMPRISING APERTURES

(71) Applicant: ELSTAR DYNAMICS PATENTS B.V., Rockanje (NL)

(72) Inventor: Anatolie MITIOGLU, Eindhoven (NL)

(21) Appl. No.: 19/474,636

(22) PCT Filed: Apr. 11, 2024
(86) PCT No.: PCT/EP2024/059851

§ 371 Date: Oct. 10, 2025

(30) Foreign Application Priority Data
Apr. 14, 2023 (EP) 23168012.5

(51) Int. Cl. G02F 1/09

(52) U.S. Cl. CPC G02F 1/092; G02F 2201/12; G02F 2202/16

(57) ABSTRACT

Some embodiments are directed to a light modulator having a first substrate and a second substrate, the first substrate and the second substrates being arranged with inner sides opposite to each other, the first substrate being transparent, at least one driving electrode being applied to the inner side of the first substrate, the driving electrode extending in a pattern across the inner side of the first substrate, the driving electrode comprises multiple apertures extending through the electrode thus allowing incident light to pass through the first substrate and the driving electrode into the optical layer, or vice versa.

### TECHNICAL FIELD

The presently disclosed subject matter relates to a light modulator, a substrate and a method for manufacturing a substrate.

### BACKGROUND

A known light modulator is disclosed in WO2022023180, included herein by reference. The known light modulator comprises transparent or reflective substrates. Multiple electrodes are applied to the substrates in a pattern across the substrate. A controller may apply an electric potential to the electrodes to obtain an electro-magnetic field between the electrodes providing electrophoretic movement of the particles towards or from an electrode.

### SUMMARY

It would be advantageous to have an improved light modulator. In an embodiment of a light modulator, at least one driving electrode is applied to the inner side of a transparent substrate, the driving electrode extending in a pattern across the inner side of the substrate. The one or more driving electrodes comprises multiple apertures extending through the electrode thus allowing incident radiation to pass through the first substrate and the driving electrode into the optical layer, or vice versa.

The incident radiation may comprise infrared radiation, and/or visible light. Having apertures arranged for infrared radiation to pass through, then the electrodes will be more transmissible for infrared radiation.

The light modulator comprises at least two substrates arranged opposite each other. At least one driving electrode may be applied to one or to both substrates, each of which may be supplied with apertures. Both substrates may be transparent.

An optical layer arranged between the first and second substrates that comprises a fluid comprising particles. A controller is configured to apply an electric potential to the at least one driving electrode to obtain an electro-magnetic field providing movement of the particles towards or from the driving electrode causing modulation of the optical properties of the light modulator.

Apertures provide various effects to a light modulator. An electrode having multiple apertures applied to it is less visible in a light modulator. This is especially important in various applications. For example, in dynamic glazing, also known as smart glass, according to an embodiment, visible electrodes are distracting. For example, in a car reducing visibility of the electrodes contributes to safety.

Electric fields have a tendency to be most effective near edges of the electrodes, by applying apertures the effectiveness of the electrodes is increased. As a result transitioning between different optical states of the light modulator is faster and more uniform.

As apertures allow more radiation into the light modulator the amount of radiation blocked by the modulator decreases. For example, in a dynamic glazing application, the amount of ambient light, e.g., sunlight, that can enter through the dynamic glazing is increased, even in a most transparent state of the light modulator. As a result, there is less need for artificial light. For example, in a green house the amount of infrared that is transmitted into the greenhouse may be increased by the use of apertures adapted for infrared radiation.

Apertures impact the scattering of light, and thus may have a contribution to optical effects such as diffraction. Having apertures allows more freedom in the light modulator design to reduce diffraction. For example, the distribution, shape, orientation, and/or size of apertures may be varied, e.g., randomized, to reduce diffraction.

In an embodiment, the multiple apertures have multiple different diameters. In an embodiment, the distribution of the multiple apertures is randomized across at least part of the at least one electrode.

In an embodiment, the light modulator is an electrophoretic light modulator. The particles are electrically charged or chargeable, and the controller is configured to apply an electric potential to the one or more driving electrodes to obtain an electro-magnetic field providing electrophoretic movement of the particles towards or the driving electrode causing modulation of the optical properties of the light modulator.

A further aspect is a substrate for use in a light modulator, and a method for manufacturing the substrate.

### BRIEF DESCRIPTION OF THE DRAWINGS

Further details, aspects, and embodiments will be described, by way of example only, with reference to the drawings. Elements in the figures are illustrated for simplicity and clarity and have not necessarily been drawn to scale. In the figures, elements which correspond to elements already described may have the same reference numerals. In the drawings,

FIG. 1a schematically shows an example of an embodiment of a building block,

FIG. 1b schematically shows an example of an embodiment of a substrate,

FIG. 1c schematically shows an example of an embodiment of a substrate,

FIG. 1d schematically shows an example of an embodiment of a substrate,

FIG. 1e schematically shows an example of an embodiment of a substrate,

FIG. 1f schematically shows an example of an embodiment of a substrate,

FIGS. 2a-2f schematically show an example of an embodiment of a substrate,

FIG. 3a schematically shows an example of an embodiment of a light modulator,

FIG. 3b schematically shows an example of an embodiment of a light modulator,

FIG. 3c schematically shows an example of an embodiment of a car,

FIGS. 4a-4c schematically show an embodiment of a light modulator,

FIG. 5a.1 schematically shows an example of an embodiment of a substrate,

FIG. 5a.2 schematically shows an example of embodiments of an aperture,

FIG. 5b schematically shows an example of an embodiment of a tessellation,

FIG. 5c schematically shows an example of an embodiment of an electrode,

FIG. 5d schematically shows an example of an embodiment of an electrode,

FIG. 5e schematically shows an example of an embodiment of an electrode,

FIG. 5f. 1 schematically shows an example of an embodiment of an electrode,

FIG. 5f.2 schematically shows an example of an embodiment of a shift,

FIG. 5g.1 schematically shows an example of an embodiment of an electrode,

FIG. 5g.2 schematically shows an example of an embodiment of an aperture,

FIG. 5h schematically shows an example of an embodiment of an electrode,

FIG. 6a schematically shows an example of an embodiment of an electrode,

FIG. 6b schematically shows an example of an embodiment of an electrode,

FIG. 6c schematically shows an example of an embodiment of an electrode,

FIG. 7a schematically shows an example of an embodiment of an electrode,

FIG. 7b schematically shows an example of an embodiment of an electrode,

FIG. 8a schematically shows a computer readable medium having a writable part comprising a computer program according to an embodiment,

FIG. 8b schematically shows a representation of a processor system according to an embodiment.

### List of Reference Numerals

The following list of references and abbreviations is provided for facilitating the interpretation of the drawings and shall not be construed as limiting the claims.
10 a light modulator
11 a first substrate
12 a second substrate
13, 13a, 13b electrodes
14, 14a, 14b electrodes
15 a fluid
16 a controller
30 particles
20 a car
21 a light modulator
40 a light modulator
41 a first substrate
42 a second substrate
43 a third substrate
46 a controller
100-102 a substrate
111-114 a main line
121-124 a main line
131-134 interdigitated electrodes
140 a building block
141-144 a building block
110, 120 a driving bus
110′, 120′ a driving bus
119, 129 a connecting zone
191, 192 a direction
603-604 a substrate
611-622 a building block
651-662 a building block
500 a substrate
501,502 an electrode edge
503 an electrode
504 a vertex
505 a line width
509 a detail
510 an aperture
511-514 an aperture
520 a serration
521 a serrated electrode edge
522 an original aperture
523 a shifted aperture
531 an aperture
532 an exclusion zone
540 an electrode
541-543 a direction
544 an aperture
601 an electrode edge
650 an aperture
602 an aperture
651 a point on an aperture edge
652-653 a distance
654 a point on an electrode edge
655 a distance
656 a serration
657 a distance
711 a low density region
712 a high density region
1000, 1001 a computer readable medium
1010 a writable part
1020 a computer program
1110 integrated circuit(s)
1120 a processing unit
1122 a memory
1124 a dedicated integrated circuit
1126 a communication element
1130 an interconnect
1140 a processor system

### DETAILED DESCRIPTION OF EMBODIMENTS

While the presently disclosed subject matter is susceptible of embodiment in many different forms, there are shown in the drawings and will herein be described in detail one or more specific embodiments, with the understanding that the present disclosure is to be considered as exemplary of the principles of the presently disclosed subject matter and not intended to limit it to the specific embodiments shown and described.

In the following, for the sake of understanding, elements of embodiments are described in operation. However, it will be apparent that the respective elements are arranged to perform the functions being described as performed by them. Further, the subject matter that is presently disclosed is not limited to the embodiments only, but also includes every other combination of features described herein or recited in mutually different dependent claims.

Substrate are disclosed, e.g., for use in a light modulator, in particular, dynamic glazing. The substrate is transparent, and at least one driving electrode is applied to a side of the substrate, the driving electrode extending in a pattern across the side of the first substrate. Interestingly, when in use in a light modulator, it is advantageous for the driving electrode to comprise multiple apertures extending through the electrode thus allowing incident radiation to pass through the first substrate and the driving electrode, or vice versa. For example, the radiation may be visible light. This has at least effects. As some light will pass through the apertures, the electrodes become less pronounced, e.g., less easily visible. Another effect of perforated electrodes, that is, electrodes having apertures, is an increased effectiveness of the electric field. It has been observed in practice that the electric field is most effective near the edges of electrodes, e.g., in moving particles to modulate the optical properties of the light modulator. By perforating or serrating electrodes, the effectiveness of the substrate in the light modulator increases.

There are many types of light modulators that use such a substrate. Some of the known light modulators are based on the electrophoretic principle. For example, the substrate may comprise multiple interdigitated driving electrodes applied to the substrate, e.g., two electrodes, each of the multiple driving electrodes being arranged in a pattern across the substrate, the multiple interdigitated driving electrodes being arranged alternatingly with respect to each other on the substrate. Having multiple interdigitated electrodes allows local control over the electric field enabling electrophoretic control of particles.

Electrophoretic light modulators are explained more extensively herein, and are used as the motivating example. In an embodiment, a light modulator comprises a first substrate and a second substrate. At least one of the first and second substrate may be according to an embodiment, having a perforated electrode. For example, the first and second substrates may be arranged with inner sides opposite to each other. Using a substrate according to an embodiment has, e.g., the effect of reducing optical interference. An optical layer is arranged between the first and second substrates. The driving electrode is arranged to modulate an electrical field in the optical layer. The optical layer comprises a fluid comprising particles, wherein the particles are electrically charged or chargeable. The particles may be moved under control of the electrical field. For example, a controller may be configured to apply an electric potential to the driving electrode to obtain an electro-magnetic field at the driving electrode providing electrophoretic movement of the particles towards or from one of the at least one driving electrode causing modulation of the optical properties of the light modulator.

Below a number of known light modulators are reviewed, showing some of the options in technology and electrodes. These known substrates can advantageously be modified by perforating the electrodes. These examples also show light modulators with varying numbers of electrodes on a substrate.

International patent applications WO2011012499 A1 (included herein by reference) and WO2011131689 (included herein by reference) disclose light modulators in the form of electrophoretic display devices, e.g., e-Ink displays. A pixel of the display comprises an accumulation electrode and a field electrode, the accumulation electrode being arranged at a storage area for accumulating charged particles away from an aperture area, and the field electrode occupying a field-electrode area being at least a part of an aperture area of the pixel, the charged particles being movable between the accumulation electrode and the field electrode. In an embodiment, two electrodes are applied on a single substrate. Accumulation electrode and/or field electrode may be perforated.

U.S. Pat. No. 10,921,678 with title ‘Electrophoretic device’, included herein by reference shows an electrophoretic device having only one patterned electrode on one of two substrates. For example, the one substrate with an electrode according to U.S. Pat. No. 10,921,678 may be replaced with a substrate according to an embodiment comprising one single electrode. For example, an embodiment comprises a first transparent substrate with a field electrode, and a second substrate opposite of the first substrate, with an accumulation electrode. The first substrate and the second substrate enclose a pixel with a fluid and particles. In use an applied electro-magnetic field to the field electrode and the accumulation electrode provides movement of the particles from the field electrode and the accumulation electrode and vice versa. The field electrode and/or the accumulation electrode may be perforated.

U.S. Pat. No. 8,054,535B2 (included herein by reference) and U.S. Pat. No. 8,384,658B2 (included herein by reference) show alternative example of electrophoretic light modulators in one of two substrates have two patterned electrodes.

Patterned electrodes are also used in dielectrophoretic light modulators. For example, US patent application US2005185104A1 (included herein by reference) and US20180239211A1 (included herein by reference) show a dielectrophoretic light modulators having a substrate with a patterned electrode. Any of these cited electrophoretic or dielectrophoretic light modulators may be adapted by perforating an electrode on a substrate according to an embodiment.

The paper “Reversible Metal Electrodeposition Devices: An Emerging Approach to Effective Light Modulation and Thermal Management”, included by reference, also shows a substrate on which a patterned electrode is applied. The patterned electrode may advantageously be arranged according to an embodiment.

An embodiment of a substrate may be used in an electrochromic device (ECD). An electrochromic device (ECD) controls optical properties such as optical transmission, absorption, reflectance and/or emittance in a continual but reversible manner on application of voltage (electrochromism). This property enables an electrochromic device to be used for applications like smart glass, electrochromic mirrors, and electrochromic display devices.

An electrochromic device is described, e.g., in the paper “Silver grid electrodes for faster switching ITO free electrochromic devices” by António Califórnia et al., included herein by reference. The paper describes the preparation of an electrochromic device, in this case one which is ITO free.

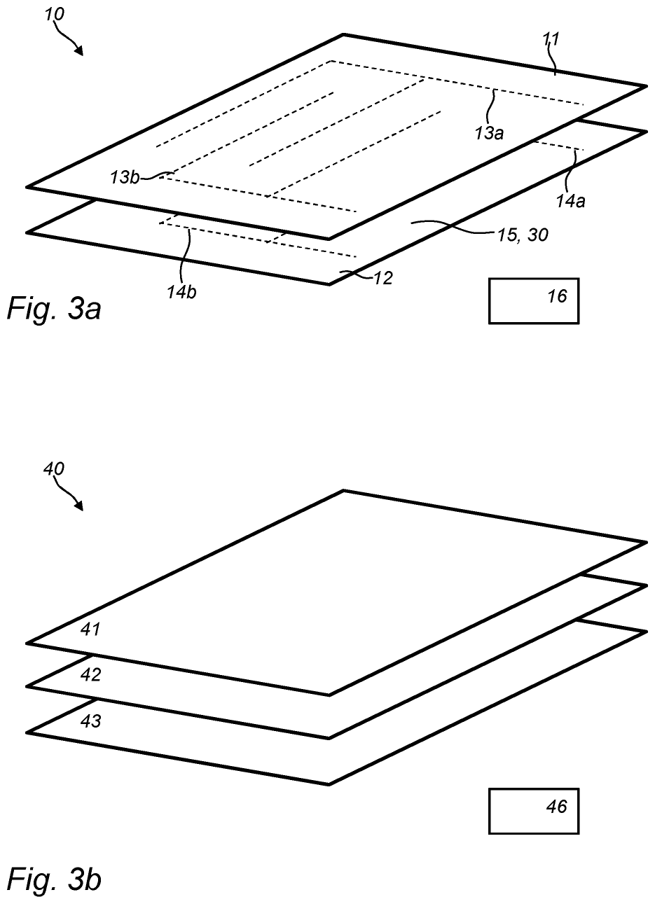

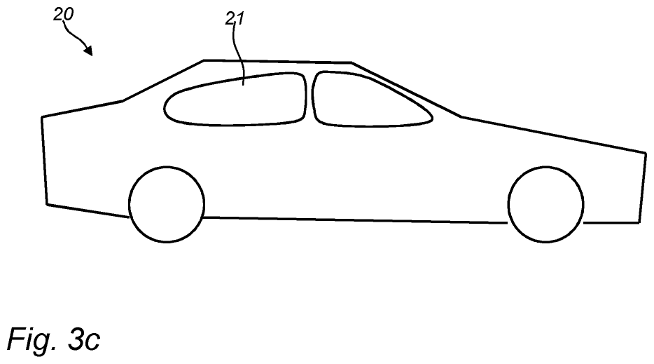

An electrochromic device uses electrically conductive electrodes applied on a substrate. The cited paper uses silver grids, made using silver ink, as electrically conductive electrodes. An electrochromic device may comprise an electrochromic material. The cited paper uses poly(3,4-ethylenedioxythiophene) polystyrene sulfonate (PEDOT:PSS). In an electrochromic device, at least one driving electrode, e.g., the electrically conductive electrode, is applied to a substrate. The driving electrode being arranged in a pattern across the substrate. The cited paper discloses two different grid patterns a regular hive and a regular ladder design. See table 1 and FIG. 3 of the cited paper.

Electrodes may be applied to a substrate by screen-printing on a substrate, in the case of the cited paper, polyethylene terephthalate (PET). The electrodes are typically an electrically conductive material, e.g., a metal or metal oxide. In the cited paper, silver ink was used to screen print the grids on PET using a RokuPrint RP 2.2 equipment and a 180 wired mesh. The samples were allowed to dry in an oven at 130° C. during 15 min. On top of these silver grids, one or two layers of PEDOT:PSS SV3 were posteriorly printed by screen printing. Light passing through an electrode, that in this case is applied in a regular pattern, the electrode, e.g., the pattern, may be perforated according to an embodiment.

For example, the metal grid used in the cited paper may be replaced by a driving electrode applied to the substrate, the driving electrode being perforated according to an embodiment.

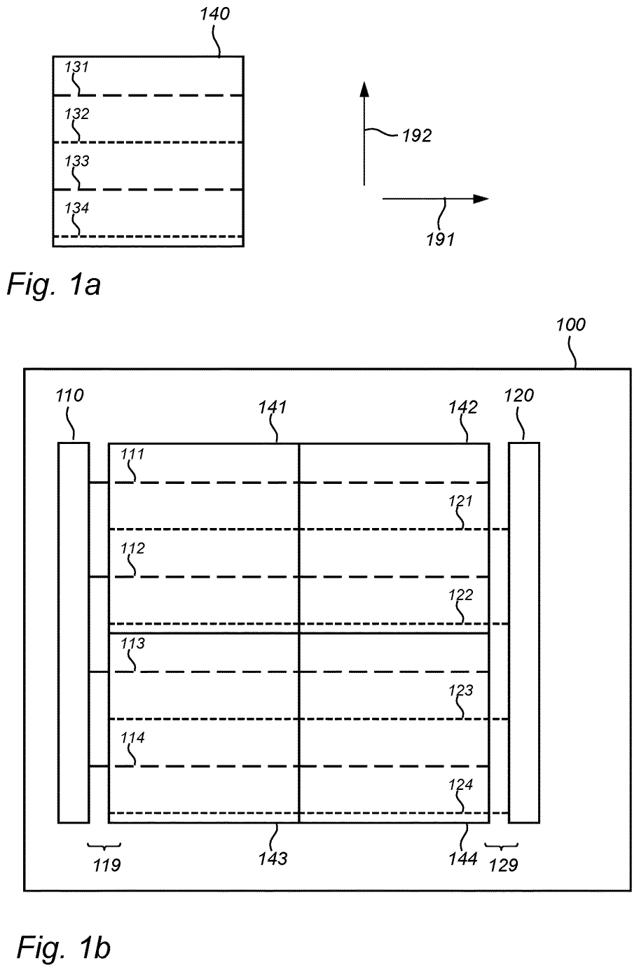

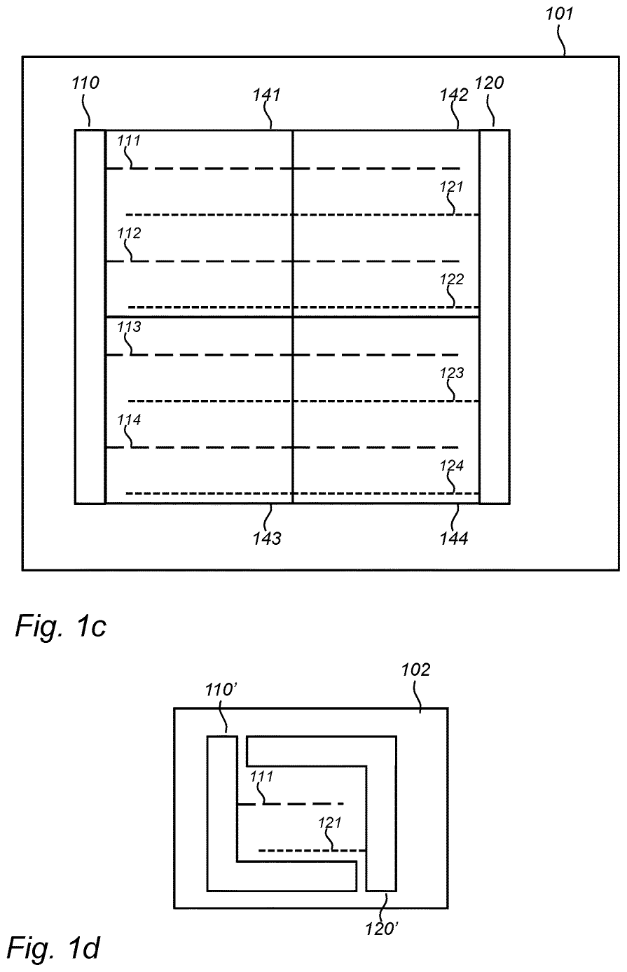

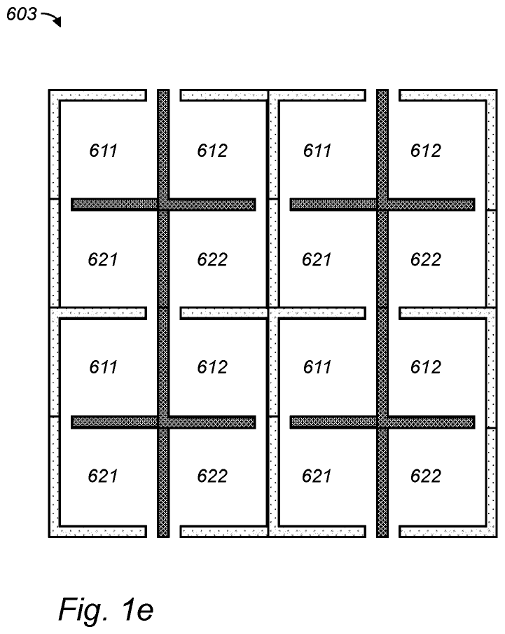

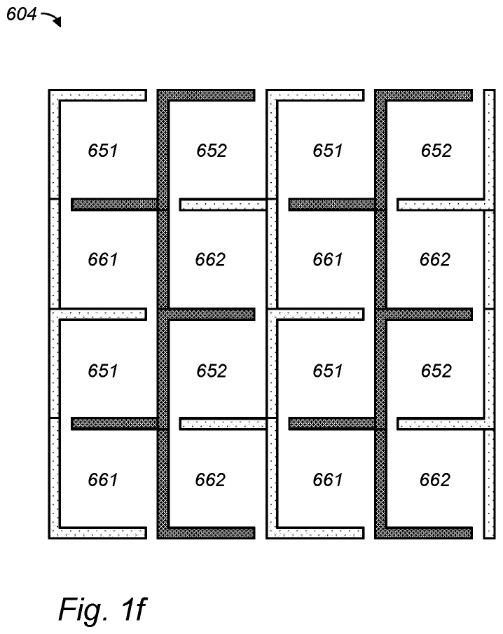

Another example of an electrochromic device is given in U.S. Pat. No. 5,161,048, with title “Electrochromic window with metal grid counter electrode and acidic polyelectrolyte”, included herein by reference. For example, an electrochromic device, may comprise a transparent electrochromic film and an ion-conductive layer disposed between a pair of electrodes. The metal grid electrode is issued for the electrodes. FIG. 1 of the patent shows a metal grid according to the cited patent. To form the counter electrode, a metal grid is disposed adjacent to the second glass substrate.

For example, in an embodiment of an electrochromic device, the electrochromic device may comprise a transparent substrate, an electroconductive electrode member, a transparent electrochromic film in contact with said electroconductive electrode member, an ion-conductive polymer in contact with said electrochromic film; and a patterned conductive electrode in contact with said ion-conductive polymer. The patterned conductive electrode may be according to an embodiment.

A substrate according to an embodiment can be beneficially applied in a number of other technologies. For example, the light modulator may be dielectrophoretic light modulator, e.g., as shown in US20050185104A1, included herein by reference. A substrate as in an embodiment may also be used in other electrowetting and OLED applications.

In OLED and electrowetting one needs electrodes on only one of the substrates. The substrate with electrodes may be according to an embodiment.

In an application of the light modulator for glazing both substrates are typically transparent. In other application, e.g., in television, e-readers, etc., only one substrate may be transparent.

In an embodiment, a driving electrode applied to a substrate comprises multiple apertures extending through the electrode thus allowing incident radiation to pass through the substrate and the driving electrode into the optical layer, or vice versa. In FIGS. 1a-4c the apertures are not visible in the figures.

FIG. 1b schematically shows an example of an embodiment of a substrate. The substrate is in particular useful for use in a light modulator, e.g., of a kind described herein. Across the substrate multiple interdigitated driving electrodes are applied to the substrate. Shown in FIG. 1b are two electrodes.

The motivating example use of the substrate is in an electrophoretic light modulator. Typically, an electrophoretic light modulator comprising at least two substrates, each having at least two driving electrodes; this is not necessary though, for example, an electrophoretic light modulator may comprise a single substrate with 2 electrodes and an opposite substrate with 1 electrode. In any case, preferably, at least one of the substrates in the light modulator is according to an embodiment.

An embodiment of a light modulator comprises a first substrate according to an embodiment and a second substrate. The first and second substrates are arranged with inner sides opposite to each other. At least one driving electrode is applied to the inner side of the first substrate. An optical layer is arranged between the first and second substrates. A controller is configured to apply an electric potential to the at least one driving electrode causing modulation of the optical properties of the light modulator. One or both of the first and second substrates are transparent and/or translucent.

There are many different kinds of light modulators that use at least one driving electrode applied to a substrate. As radiation is transmitted through the substrate, some of the radiation may be blocked by the electrodes, using apertures can reduce this reduction. For example, for visible light this results in clearer, more transparent glass. The optical layer and controller may be arranged to modulate optical properties using effects that depend on the potential on the driving electrode; examples including the dielectrophoretic effect and the electrophoretic effect. For example, optical modulation may comprise the modulation of particles arranged in the optical layer. The number of driving electrodes may range from one on a single substrate, to multiple driving electrodes on one or both substrates.

The optical layer arranged between the first and second substrates may comprise particles, e.g., suspended in a fluid. The controller may be configured to apply an electric potential to the driving electrodes causing the particles to move thus modulating the optical properties of the light modulator.

In an embodiment, the particles comprise electrically charged or chargeable particles, and the controller is configured to apply an electric potential to the driving electrode to obtain an electro-magnetic field providing electrophoretic movement of the particles. In an embodiment, the electro-magnetic field is arranged between at least two driving electrodes arranged on the same substrate or arranged on different substrates.

In an embodiment, the particles comprise dielectric particles, and the controller is configured to apply an electric potential to the driving electrode to apply an electric field gradient to the particles enabling the particles to be moved under the action of dielectrophoretic forces.

The controller may apply an electric signal to one or more of the driving electrodes. Embodiments that control dielectrophoretic forces may use a signal that comprises a DC signal and/or an AC signal. Embodiments that control electrophoretic forces may use a signal that comprises a DC signal and/or an AC signal.

Shown in FIG. 1b are two driving electrodes on the same surface. The two driving electrodes are indicated in FIG. 1b in two different dashing styles. There could be more than two electrodes on the same side of the substrate, e.g., to facilitate more fine-grained control of voltage differences across the substrate. The driving electrodes are applied to a same side of the substrate. Applying electrodes to a substrate may be done lithographically, e.g., using a mask representing the electrodes pattern. Electrodes may also be applied by embedding them in the substrate.

A driving electrode is electrically connected, e.g., has the same electric potential everywhere. A driving electrode may comprise driving busses and main lines. At least, the main lines are interdigitated with main lines of a further driving electrode. Typically, the driving electrodes extend in a substantially straight line across the substrate, while the main lines are convoluted.

In an embodiment, the two substrates of a light modulator each have two electrodes arranged at its inner surface. Though, as mentioned, multiple electrodes on one or both substrates is not needed. For example, an embodiment of a light modulator comprises a first substrate and a second substrate. For example, the first substrate may comprise one driving electrode, the second substrate may not comprise driving electrodes. For example, the first substrate may comprise two driving electrodes, the second substrate may comprise one driving electrode. For example, the first substrate may comprise two driving electrodes, the second substrate may comprise two driving electrodes. For example, the first substrate may comprise more than two driving electrodes, the second substrate may comprise two or more driving electrodes.

Light modulators, wherein each substrate comprises two driving electrodes are used as a motivating example, though. Designs of substrates featuring two driving electrodes may be adapted to have a single driving electrode, e.g., by connecting the two driving electrodes, or by removing one of the driving electrodes. Adapting a substrate in such a manner may make it suitable for use in different technologies.

Each of the multiple driving electrodes are arranged in a pattern across the substrate. The multiple driving electrodes are arranged alternatingly with respect to each other on the substrate. Typically, a driving electrode comprises multiple main lines, that each stretch across the substrate. The main lines of the driving electrodes alternate, e.g., interdigitate. For example, in FIG. 1b the first driving electrode comprises main lines 111-114, and the second driving electrode comprises main lines 121-124. The driving electrodes are each driven by its driving bus. FIG. 1b shows two driving buses: driving bus 110 and driving bus 120. The driving electrodes also serve to connect the main lines together. For example, in FIG. 1b, the driving bus 110 drives and connects main lines 111-114; and the driving bus 120 drives and connects main lines 121-124. There can be more main lines than the four shown in this example. The use of main lines is advantageous as it reduces the length of the electrodes, but it is not necessary. A design using only one main line per driving electrode is not impossible, though having multiple is advantageous.

The multiple of main lines of the first and second electrode are arranged alternatingly with respect to each other on the substrate.

In this example, there are no other connections between the main lines of an electrode than through the common driving bus. In an embodiment, a driving electrode comprises a mesh electrode, that is, it may have additional electrical connection may be added between electrode lines of the same driving electrode. This increases the reliability of the electrode. Such additional connections typically cross an electrode line of another driving electrode, which may be resolved by placing the additional electrical connection in part on a different level with respect to the substrate than the electrode line being crossed. For example, one may place the entire driving electrodes at a different level than another driving electrode. In this way, additional connections may be placed without short circuits arising. Note that an apertures and its edges are at the same level as the electrode in which it is placed.

A motivating application for a substrate such as substrate 100 is in smart glazing, e.g., a light modulator, which may be applied in domestic housing, offices, green houses, cars, and the like. The level of transparency or reflectivity of the smart glazing can be adapted electrically. For example, in smart glazing two substrates such as substrate 100 would be stacked so that the sides on which the two electrodes are applied face each other. A fluid with particles is enclosed between the two substrates. Smart-glazing embodiments are further discussed below. In an embodiment, electrodes, e.g., two or more electrodes are applied to one surface of each substrate. There could also be one, two or more electrodes on the other surface of substrate 100, e.g., to facilitate stacking of three or more substrates.

Some embodiments below show examples of modulating a transparency or reflectivity level. Light modulators may be adapted for other optical effects. For example, if desired, embodiments could be modified to different levels of translucency instead of different levels of transparency. If desired, the type of particle that is used in an embodiment can be varied, e.g., to particles that differ in which wavelengths they absorb or reflect, and how specular of diffuse the reflection is. For example, in an embodiment, a light modulator can modulate different levels of reflection. Particles can also emit light. Stacking multiple optical layers further increases the possibilities.

Having two sets of alternating main lines is sufficient to provide electrically adaptable glazing; due to the alternating two sets the electric field at any part of the substrate can be controlled as two opposite electrodes border the part from two opposing sides.

Interestingly, the pattern in which the driving electrodes stretch across the substrate is created by multiple repeated building blocks. Shown in FIG. 1b, the driving electrodes on substrate 100 shows four blocks: blocks 141, 142, 143 and 144 which are all substantially the same. The number of building blocks may be larger than four. The building blocks repeat in both directions across the substrate, e.g., a first direction 191, e.g., an x-direction, shown horizontally in the figure, and a second direction 192, e.g., a y-direction, shown vertically in the figure. Using building blocks is advantageous as it allows manufacture using a stepper machine; using building blocks is not necessary.

For example, FIG. 1a schematically shows an example of an embodiment of a building block 140. Building block 140 comprises multiple interdigitated electrodes extending in at least 2 directions across the building block. Shown in FIG. 1a are four electrodes: electrode 131-134. When the building blocks are repeated across a substrate in two directions, the electrodes in the building block will form the driving electrodes, e.g., form the multiple main lines of the driving electrodes. Note that the building blocks are typically connected in a substrate-electrode design tool. Typically, a building block comprise more than four electrode lines. For example, in a range of embodiments between 8 and 12 main lines are used. The number of electrode lines can be much higher though. For example, a building block may comprise many short electrode lines near the edges that connect to lines of other building blocks when the block is repeated. Taking such short offshoots into account, the number of lines could go up to, say, 50. Clearly, when using larger building blocks, the number of electrode lines may go up as well. In an embodiment, the number of electrode lines in a building block is between 8 and 50, or between 8 and 25, etc.

The driving electrodes that are formed by repeating building blocks are connected to the driving busses. Typically, electrode lines in a building block are connected to electrode lines in neighboring blocks by mering corresponding electrode lines; this is not necessary though, between repeated building blocks connection zones can be inserted that connect corresponding electrode lines.

This step can connect up multiple of the main lines together thus forming a single driving electrode. FIG. 1b shows two connecting zones 119 and 129 in which the main lines belonging to the same driving electrode are connected to driving bus 110 and driving bus 120 respectively.

The electrodes that are shown in FIG. 1a are alternately dashed in the same dashing style of FIG. 1b. Indeed, it happens to be the case in this example, that a particular electrode of the building block of FIG. 1a will always end up in the first driving electrode or in the second electrode, e.g., as indicated in this case by the dashing style. This is, however, not necessarily the case. An electrode in a building block may end up as part of the first driving electrode or as part of the second driving electrode. This can change, e.g., as a result of the parity of the number of electrodes in the building block, the pattern in which the building blocks are repeated, etc.

For example, a particular pattern of repeated building blocks may be used for a light modulator with two driving electrodes, in which one might assign alternating main lines to the two driving electrodes. However, the same pattern of repeated building blocks may be used for a light modulator with three driving electrodes, in which one might assign every next set of three main lines to the three driving electrodes.

Furthermore, the building block shown in FIG. 1a is square, but this is also not needed. For example, a building block may be rectangular. In an embodiment, building block shape(s) could form a so-called tessellation. For example, a building block may be a triangle, a hexagon or even a combination of plane-filling shapes.

As said, FIGS. 1a and 1b are schematic. This is especially the case for the depiction of the electrodes. An electrode as shown in FIG. 1a is straight, however, in an embodiment, an electrode on the building block is more convoluted, e.g., curved. By adapting the shape of the electrodes undesirable diffraction effects can be altered.

In an embodiment, a dimmable mirror comprises a light modulator according to an embodiment. For example, the dimmable mirror comprises a transparent substrate, an optical layer, and a reflective substrate. One or both of the substrates is according to an embodiment. The dimmable mirror may be electrophoretic. Typically, each substrate has two electrodes, but this is not necessary.

FIG. 1c schematically shows an example of an embodiment of a substrate 101. Substrate 101 is similar to that of substrate 100, except for how the main lines are connected that formed from the electrodes on the building blocks to the driving buses. In
FIG. 1a, a connection zone is inserted between the repeated building blocks and the driving buses 110 and 120. In the connection zone, the main lines belonging to the same driving electrode are connected to the same driving bus. In FIG. 1c, the driving bus are directly adjacent to the building blocks. To avoid that a driving bus would connect to a main line of a different driving electrode, some of the building blocks are modified.

For example, building block 141 may be a copy of building block 140, but the electrode 134 is shortened so that the main line 122 of which line 134 is a part does not connect to bus 110. In FIG. 1c the building blocks are substantially the same except that a disconnect is introduced in some electrodes of building blocks next to the driving bus to avoid connecting a main line with the driving bus. Although all building blocks shown in FIG. 1c are modified in this way, in an embodiment the majority of building blocks would not be modified, e.g., the building blocks that are not adjacent to driving busses 110, 120.

FIG. 1d schematically shows an example of an embodiment of a substrate 102. In an embodiment, the electrodes in a building block each connect the same opposite sides of the building block. This has the consequence that the main lines that are formed by the electrodes on the building block connect opposite sides of the substrate. In such a situation having only two driving buses, e.g., each extending along an opposite side of the substrate, is sufficient to connect and drive the driving electrodes.

It is however not required for the electrodes in a building block to connect opposite sides of the building block. Although typically all electrodes in a building block will connect two sides of the building block, it is not required that these two sides are opposite. The reasons for this, is that an electrode may be continued by a next building block. In such a situation most main lines will still connect the same two opposite sides, but at the edge of the substrate this may not happen, as there are no further building blocks there to carry the electrode forward. To allow for more intricate electrode designs on the building blocks, the main line may be connected to a driving bus from two sides, e.g., two sides of the substrate that are adjacent to the same corner of the substrate.

Shown in FIG. 1d, is a driving bus 110′ extending along two sides of the substrate and a driving bus 120′ extending along the other two sides of the substrate.

An advantage of this configuration is that the driving buses can be made in the same plane. This is not necessary though. A driving bus could connect from three or all four sides if desired, e.g., to further increase design freedom for the building blocks. Various examples are given herein.

Note that driving electrodes, e.g., driving busses, and/or main lines are allowed to overlap. This is possible, e.g., by causing a part of dielectric material between the electrodes. For example, such overlapping electrodes could be partly or fully in different planes of the substrate.

For example, in an embodiment one might depose the first driving electrode. Then locally depose a dielectric, and finally depose a second driving electrode. The dielectric is arranged to cover at least the points where the first and second electrode cross. A via could be used to the lower first driving electrode, e.g., to connect to it. The deposing of the driving electrodes may include the deposing of the driving busses.

FIG. 1e schematically shows an example of an embodiment of a substrate 602. In FIG. 1e, a building block has been copied multiple times. To obtain substrate 602, the building block is copied by repeated translation in x-direction and y-direction. Each of the building blocks shown in FIG. 1e can be obtained by a direct translation of any other building blocks.

A disadvantage with this configuration is that the driving bus of different driving electrodes end up facing each other. To avoid a short circuit, a small amount of space has been left, e.g., a comparable width as between driving electrodes, e.g., 50 micrometer. Not shown in FIG. 1e, but the various parts of the translated driving busses, need to be connected together, e.g., with electrode lines.

For example, indicated at arrow 640, a vertical furrow is formed; that is, two electrode lines that extend in parallel close to each other. Similar furrows exist in the horizontal direction. Such furrows have been found to have a detrimental effect on diffraction. If the building block has low diffraction, then the design may still be better than patterns using less good building blocks, but it would be desirable to avoid these furrows.

FIG. 1f schematically shows an example of an embodiment of a substrate 603. In substrate 603 the building block is repeated across the substrate, but it is arranged to avoid furrows as in FIG. 1e. In this embodiment, building blocks are translated and mirrored, in this case in two directions.

Building block 611 has been mirrored in the y-direction to form building block 621. Building block 621 has been arranged directly at the bottom of building block 611. Building block 611 has been mirrored in the x-direction to form building block 612. Building block 612 has been arranged directly at the right of building block 611. Building block 611 has been mirrored in the x-direction as well as in the y-direction to form building block 622. For example, the mirroring may have as mirroring axis a side of the building block.

By mirroring the building block it is ensured that driving busses of the same driving electrode end up next to each other on the substrate. By merging these driving busses a furrow is avoided, and diffraction is reduced.

In an embodiment, at least the driving electrodes on the substrate have mirror symmetry; in an embodiment the driving electrodes and driving busses have mirror symmetry. For example, the substrate is symmetric over an x-axis and/or over a y-axis. This is an important advantage in manufacturing, as this allows the top and bottom substrate to be equal. Eliminating the need to produce separate substrates for the top and bottom of a light modulator, also eliminates the need to keep track of separate type substrates. Moreover, having symmetry in the substrates allows a broken top substrate to be replaced by a bottom substrate and vice versa—as they are the same. A straight line, e.g., a driving bus along the mirror symmetry axis is helpful as the design can be mirrored around it. Using building blocks in mirrored and unmirrored form helps to make mirror symmetric design.

This is particularly advantageous in manufacturing with photolithography steps for patterning electrodes as the same substrate patterning can be used for both substrates of the light modulator limiting production costs. Presence of straight bus bars attached on the building blocks or part of each building blocks facilitates this effect. Having a symmetrical design in one direction to use same electrode pattern for all substrates is possible without a straight bus bars, for example, by local modification of the electrode design at the edge of symmetry line. In an embodiment, the driving electrodes pattern have at least 1 symmetry in 1 direction, e.g., using tiling building blocks with mirroring and/or rotation enable electrode pattern design across the substrate.

Apertures may, or may not, be applied to the driving bus. An advantage of a driving bus without apertures applied to it, is that it has a lower resistance. On the other hand, the driving bus may obstruct light so that apertures may be applied to address this.

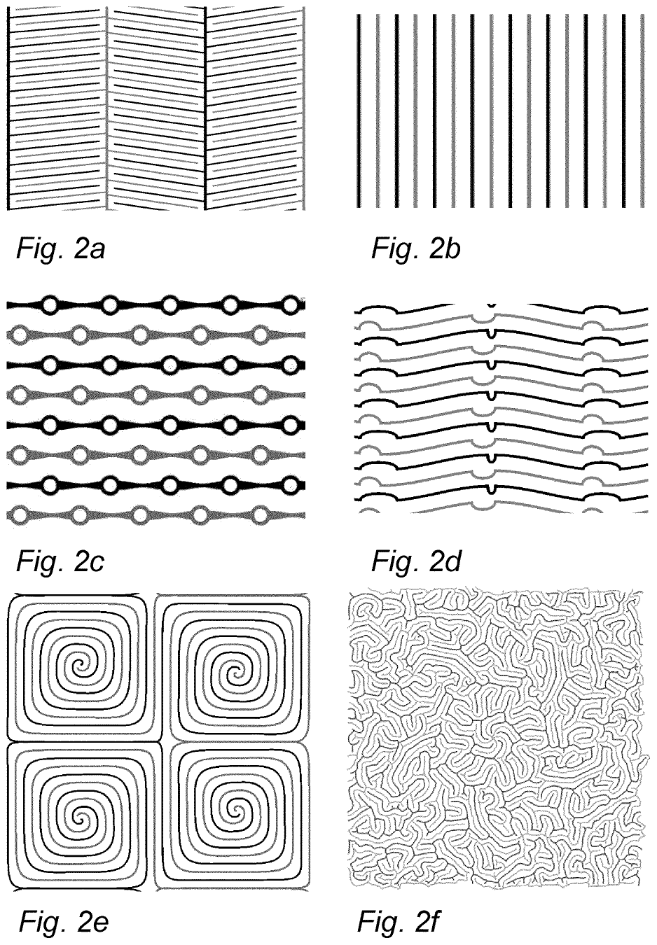

FIGS. 2a-2f schematically show examples of substrates with interdigitated electrodes. These may be embodied on a substrate with two electrodes, e.g., by alternatingly connected electrodes. FIGS. 2a-2d may also be embodied on a substrate with multiple electrodes, e.g., by connecting in sequences of 3 or 4 or more electrodes.

FIGS. 2e and 2f show designs with two driving electrodes on the surface of the substrate. Either design could be modified to have only a single driving electrodes on the surface of the substrate, e.g., by removing one of the two driving electrodes. For example, such a modified design could be used in a light modulator that uses a substrate with a single electrode.

The designs shown can be realized in a single plane, without having crossing electrodes. In particular if these designs are connected to two driving buses, no crossing electrodes are needed. When more than two driving electrodes are used, or if more complicated electrode patterns are used, then crossing of the electrodes may be used, or may even become necessary. Such crossings are possible however, for example, at the location where two electrode lines cross a dielectric material may be arranged between the electrodes. For example, such an insulator may be deposited at the crossing location. For example, a first driving electrode is in a first plane of the substrate and a second driving electrode is in a second plane of the substrate.

Two substrates according to an embodiment may be combined to form a light modulator. The light modulator is particularly suited to glazing. An exemplary embodiment of a light modulator is shown below.

FIG. 3a schematically shows an embodiment of a light modulator 10, which may be applied in smart glazing.

Reference is made to patent application PCT/EP2020/052379, which is included herein by reference; this application comprises advantageous designs for light modulator, which may be further improved, e.g., by including electrodes, building blocks, and/or substrates as explained herein.

Light modulator 10 can be switched electronically between a transparent state and a non-transparent state and vice versa, or between a reflective state and a non-reflective state and vice versa. Light modulator 10 comprises a first substrate 11 and a second substrate 12 arranged opposite to each other. On an inner-side of first substrate 11 at least two electrodes are applied: shown are electrodes 13a, 13b. These at least two electrodes are together referred to as electrodes 13. On an inner-side of second substrate 12 at least two electrodes are applied: shown are electrodes 14a, 14b. These at least two electrodes are together referred to as electrodes 14.

A fluid 15 is provided in between said substrate. The fluid comprises particles 30, e.g., nanoparticles and/or microparticles, wherein the particles are electrically charged or chargeable. For example, particles may carry a charge on their surface intrinsically. For example, the particle may be surrounded by a charged molecule.

The electrodes are arranged for driving particles 30 to move towards or away from electrodes, depending on the electric field applied. The optical properties, in particular the transparency or reflectivity of the light modulator depends on the location of particles 30 in the fluid. For example, a connection may be provided for applying an electro-magnetic field to the electrodes.

At least one, but preferably both electrodes 13 and 14 are according to an embodiment, though they are shown schematically in the figures.

In an embodiment, at least one of the electrode pattern on the first substrate and the electrode pattern on the second substrate have a low calculated pixelated noise metric which contributes to diffraction. Interestingly, the electrode patterns on the substrates might not satisfy the bound on their pixelated noise metric individually, but their combination might, that is their superimposition. As this is the pattern that would be visible when looking through the light modulator, a low pixelated noise metric in the superimposition would also contribute to low diffraction. Suitable bounds for the patterns on the first and/or second substrate or for the superimposition include: below 6.05%, or 5%, or 4%

In an example, substrate 11 and substrate 12 may be optically transparent outside of the electrodes, typically >95% transparent at relevant wavelengths, such as >99% transparent. Taking electrodes into account, transparency can be much lower, e.g., 70%. The term “optical” may relate to wavelengths visible to a human eye (about 380 nm-about 750 nm), where applicable, and may relate to a broader range of wavelengths, including infrared (about 750 nm-1 μm) and ultraviolet (about 10 nm-380 nm), and sub-selections thereof, where applicable. In an exemplary embodiment of the light modulator a substrate material is selected from glass, and polymer.

In another example, one substrate, such as a bottom substrate 12, may be reflective or partially reflective, while the top substrate 11 is transparent. The optical properties, in particular the reflectivity of the light modulator depends on the location of particles 30 in the fluid. When the panel is in the open state (vertical drive), the particles will mostly be located between opposite electrodes of the two substrates, such that incident light can pass through the transparent top substrate and the optical layer relatively unhindered, and is reflected or partially reflected on the bottom substrate.

The distance between the first and second substrate is typically smaller than 30 μm, such as 15 μm. In an exemplary embodiment of the light modulator a distance between the first and second substrate is smaller than 500 μm, preferably smaller than 200 μm, preferably less than 100 μm, even more preferably less than 50 μm, such as less than 30 μm.

In an example the modulator may be provided in a flexible polymer, and the remainder of the device may be provided in glass. The glass may be rigid glass or flexible glass. If required, a protection layer may be provided on the substrate. If more than one color is provided, more than one layer of flexible polymer may be provided. The polymer may be polyethylene naphthalate (PEN), polyethylene terephthalate (PET) (optionally having a SiN layer), polyethylene (PE), etc. In a further example the device may be provided in at least one flexible polymer. As such the modulator may be attached to any surface, such as by using an adhesive.

Particles 30 may be adapted to absorb light and therewith preventing certain wavelengths from passing through. Particles 30 may reflect light; for example, the reflecting may be specular, diffusive, or in between. A particle may absorb some wavelengths, and reflect others. Particles may also or instead emit light, e.g., using phosphorescence, fluorescence, or the like. Even the fluid may emit light, which emittance is modulated by changing the location of particles.

In an exemplary embodiment of the light modulator a size of the nanoparticles is from 20-1000 nm, preferably 20-300 nm, more preferably smaller than 200 nm. In an exemplary embodiment of the light modulator the nanoparticles/microparticles may comprise a coating on a pigment, and preferably comprising a core. In an exemplary embodiment of the light modulator the coating of the particles is made from a material selected from conducting and semiconducting materials.

In an exemplary embodiment of the light modulator the particles are adapted to absorb light with a wavelength of 10 nm-1 mm, such as 400-800 nm, 700 nm-1 μm, and 10-400 nm, and/or are adapted to absorb a part of the light with a wavelength-range falling within 10 nm-1 mm (filter), and combinations thereof.

In an exemplary embodiment of the light modulator the particles are electrically charged or chargeable. For example, a charge on the particles may be 0.1 e to 10 e per particle (5*10⁻⁷−0.1 C/m²).

In an exemplary embodiment of the light modulator the fluid is present in an amount of 1-1000 g/m², preferably 2-75 g/m², more preferably 20-50 g/m², such as 30-40 g/m². It is a big advantage that with the present layout much less fluid, and likewise particles, can be used.

In an exemplary embodiment of the light modulator the particles are present in an amount of 0.01-70 g/m², preferably 0.02-10 g/m², such as 0.1-3 g/m².

In an exemplary embodiment of the light modulator the particles have a color selected from cyan, magenta, and yellow, and from black and white, and combinations thereof.

In an exemplary embodiment of the light modulator the fluid comprises one or more of a surfactant, an emulsifier, a polar compound, and a compound capable of forming a hydrogen bond.

Fluid 15 may be an apolar fluid with a dielectric constant less than 15. In an exemplary embodiment of the light modulator the fluid has a relative permittivity er of less than 100, preferably less than 10, such as less than 5. In an exemplary embodiment of the light modulator, fluid 15 has a dynamic viscosity of above 10 mPa.s.

Electrodes 13a, 13b and electrodes 14a, 14b are in fluidic contact with the fluid. The fluid may be in direct contact the electrodes, or indirectly, e.g., the fluid may contact a second medium with the electrode, such as through a porous layer. In an embodiment, the electrodes cover about 1-30% of the substrate surface. In an embodiment, the electrodes comprise an electrically conducting material with a resistivity of less than 100 nom (at 273K; for comparison typically used ITO has 105 nΩm), which is similar to an electrical conductivity >1*10⁷ S/m at 20° C.). In an embodiment of the light modulator electrodes comprise copper, silver, gold, aluminum, graphene, titanium, indium, and combinations thereof, preferably copper. The electrodes may be in the form of microwires embedded in a polymer-based substrate; for example, copper microwires.

A connection for applying an electro-magnetic field to the electrodes, wherein the applied electro-magnetic field to the electrodes provides movement of the nano- and microparticles from a first electrode to a second electrode and vice versa. A connection for applying an electro-magnetic field to the electrodes may be provided. For example, in an exemplary embodiment of the light modulator an electrical current is between −100-+100 μA, preferably −30-+30 μA, more preferably −25-+25 μA. For example, a power provider may be in electrical connection with the at least two electrodes. The power provider may be adapted to provide a waveform power. At least one of amplitude, frequency, and phase may be adaptable to provide different states in the light modulator. For example, these aspects of the power may be adapted by a controller.

Light modulator 10 may comprise one or more segments, a segment being a single optically switchable entity, which may vary in size. The substrates enclose a volume, which may be a segment, at least partly.

The present device may comprise a driver circuit for changing the appearance of (individual) segments by applying an electro-magnetic field. As such also the appearance of the light modulator, or one or more parts thereof, may be changed. For example, a segment may have an area of at least 1 mm². The present design allows for stacking to allow for more colors; e.g., for full color applications a stack of two or three modulators could provide most or all colors, respectively. Apertures are not needed for electrical isolation, as the edge of an aperture is electrically connected. Filling in an aperture with electrically conducting material would not affect the operation of the light modulator.

Having one or more segments allows the light modulator to be controlled locally; this is advantageous for some applications, but not necessary. For smart glazing, a light modulator may be used with or without segments. For example, applied in smart glazing, transparency or reflectivity may be controlled locally, e.g., to block a sun-patch without reducing transparency or reflectivity in the whole window. Segments may be relatively large, e.g., having a diameter of at least 1 mm, or at least 1 cm, etc.

In an exemplary embodiment of the light modulator substrates (11,12) are aligned, and/or electrodes (13,14) are aligned. For example, electrodes 13a, 13b and electrodes 14a, 14b may be aligned to be opposite each other. In aligned substrates, electrodes on different substrates fall behind each other when viewed in a direction orthogonal to the substrates. When the light modulator is disassembled, and the substrates are both arranged with electrodes face-up, then the electrode patterns are each other's mirror image.

Aligning substrates may increase the maximum transparency or reflectivity of the light modulator, on the other hand, when selecting a light modulator for more criteria than the range of transparency or reflectivity, etc., it may be better not to align or not fully align the two substrates. Light modulators can be stacked. For example, two stacked light modulators can be made from three substrates, wherein the middles one has electrodes on both its surfaces. In an embodiment of the light modulator optionally at least one substrate 11,12 of a first light modulator is the same as a substrate 11,12 of at least one second light modulator. For stacked modulators, alignment may also increase maximum transparency or reflectivity, but it may be detrimental to other considerations, e.g., diffraction.

FIG. 3b schematically shows an example of an embodiment of a light modulator 40. Light modulator 40 is similar to light modulator 10, except that it comprises multiple optical layers; in the example as shown two optical layers. There may be more than two optical layers. Each optical layer is arranged between two substrates. Light modulator 40 can be regarded as a stack of two-substrate light modulators as in FIG. 3a. As shown, light modulator 40 comprises three substrates: first substrate 41, second substrate 42 and third substrate 43. Between substrates 41 and 42 is an optical layer, and between substrates 42 and 43 is an optical layer. The optical layers may be similar to those in light modulator 10. A controller 46 is configured to control electrical current on the electrodes of the substrates. For example, in FIG. 3b, controller 46 may be electrically connected to at least 4 times 2 equals 8 electrodes.

Interestingly, the particles in the multiple optical layers may be different so that the multiple layers may be used to control more optical properties of the light modulator. For example, particles in different optical layers may absorb or reflect at different wavelengths, e.g., may have a different color. This can be used to create different colors and/or different color intensities on the panel by controller 46. For example, a four-substrate panel may have three optical layers with different color particles, e.g., cyan, yellow, and magenta, respectively. By controlling the transparency or reflectivity for the different colors a wide color spectrum may be created.

The surfaces of the substrates that face another substrate may be supplied with two or more patterns, e.g., as in an embodiment. For example, the outer substrates 41 and 43 may receive electrodes only on an inner side, while the inner substrate, e.g., substrate 42, may have electrodes on both sides.

Substrates 41 and 42 may together be regarded as an embodiment of a light modulator. Likewise, substrates 42 and 43 may together be regarded as an embodiment of a light modulator.

FIG. 3c schematically shows an example of an embodiment of a car 20 having smart glazing for windows 21. This is a particularly advantageous embodiment, since while driving the level of incident lighting can change often and rapidly. Using smart glazing in a car has the advantage that light levels can be maintained as a constant level by adjusting the transparency of the car windows. Moreover, the reduced diffraction effect improves safety as it reduces driver distraction. Car 20 may comprise a controller configured for controlling the transparency or reflectivity of windows 21.

Smart glazing can also be used in other glazing applications, especially, where the amount of incident light is variable, e.g., buildings, offices, houses, green houses, skylights. Skylights are windows arranged in the ceiling to allow sunlight to enter the room.

The light modulator may have two optical states, e.g., a transparent state and a non-transparent state, or a reflective state and a non-reflective state. The light modulator, e.g., light modulator 10 or light modulator 40 may be configured to
switch to the second optical state, e.g., the non-transparent state or to the non-reflective state by creating an alternating voltage on at least one of the first and second substrates, applying an alternating current between at least a first electrode and a second electrode on the first substrate and/or between a first electrode and a second electrode on the second substrate, and
switch to the first optical state, e.g., the transparent state or to the reflective state by creating an alternating voltage between the first and second substrate, applying an alternating current between a first electrode on the first substrate and a first electrode on the second substrate, and/or between a second electrode on the first substrate and a second electrode on the second substrate.

The electrode pattern on the first substrate is arranged at least in part in the same pattern as a second electrode on the second substrate. Typically, the electrodes oppose each other, but the pattern of the first electrode and second electrode may also be shifted with respect to each other.

A protective coating may be provided on at least a part of the inner surface area of at least one of the first substrate and the second substrate is provided.

In an embodiment, at least one of the substrates is transparent. In an embodiment, the first substrate and/or the second substrate are transparent.

A driving signal applied to driving electrodes typically has a varying voltage. For example, a power provider may be operated at an AC frequency for switching to a transparent state or to a non-transparent state. Such a signal may have a frequency between, say, 1-1000 Hz. A balanced electrolysis current may be obtained by continuously switching the polarity of oppositely charged electrodes on the first and on the second substrates and/or between the first and the second substrates.

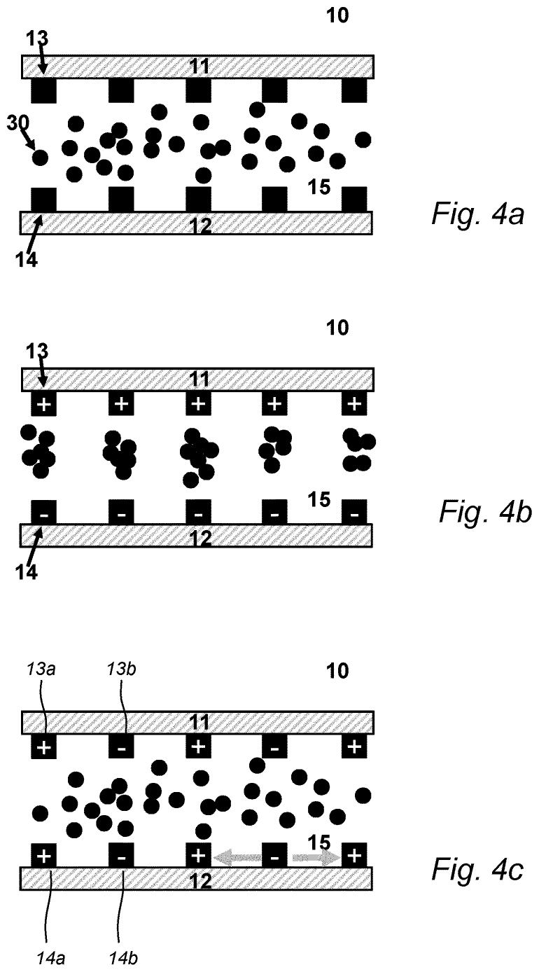

FIGS. 4a-4b schematically show a side view of an embodiment of a light modulator in use. Applying an electric field to the electrodes on the substrates causes an electrical force on the particles. Using this effect, the particles can be moved around and so different transparency or reflectivity states can be caused in the light modulator. A controller may control the electric field, e.g., its amplitude, frequency, and phase. In an embodiment, the controller is connected to at least four electrodes: two for each substrate. But more electrodes may be used and connected to the controller; for example, more than 2 electrodes may be used for a substrate to better fine-tune grey scaling, and driving to non-transparent or non-reflective state. Multiple electrodes may also be used to support multiple segments on the substrate.

FIG. 4a shows the light modulator without an electric field being applied. No electric force is yet applied on particles 30 suspended in fluid 15, in FIG. 4a.

In the configuration shown in FIG. 4a, a conducting electrode pattern, arranged on the top substrate is completely or substantially aligned with a conducting electrode pattern on the bottom substrate. The conducting electrode pattern may be deposited on a transparent or (partially) reflective glass substrate or may be embedded in a plastics substrate, etc.

Alignment between the top-electrode pattern and the bottom electrode pattern contributes to a wider range of achievable levels of transparency or reflectivity. However, alignment is not needed, as similar effects can be obtained without alignment. Without alignment, a range of transparency or reflectivity is likewise obtained.

Note that in these examples, reference is made to the top substrate and the bottom substrate to refer to substrate that is higher or lower on the page. The same substrates could also be referred to, e.g., as the front substrate and back substrate, since in a glazing application, the substrates would be aligned vertically rather than horizontally.

FIG. 4b shows the light modulator wherein, say at an instance P1, a potential +V1 is applied to each microwire electrode on the top substrate, while a negative voltage, say −V1, is applied to each microwire electrode of the bottom substrate. Thus, in this case, the same positive potential is applied to all electrodes 13, and the same negative potential is applied to electrodes 14. The difference in potential causes negatively charged particles to flow to the vicinity of the electrodes of the top substrate, where the particles will substantially align with the top electrodes. As a result, if both the top and bottom substrate are transparent, the transparency of light modulator 10 will increase. Likewise, if, e.g., the top substrate is transparent and the bottom substrate is reflective, the reflectivity of light modulator 10 will increase If the solution contains positively charged particles they will flow to the vicinity of the electrodes of the bottom substrate, where those particles will substantially align with the bottom electrodes.

A similar transparency or reflectivity can be achieved, when in a second instance, P2, of the on-state, the voltages of the top electrodes and bottom electrodes are reversed in contrast to the instance of P1. In the instance P2, the voltage of each electrode on of the top substrate are now supplied with a negative potential −V1 while the voltages of the aligned electrodes of the bottom substrate are supplied with a positive potential. This state is similar to the state shown in FIG. 4b, but with top and bottom substrates reversed. In this configuration the transparency or reflectivity of light modulator 10 is also high.

Interestingly, by switching between a positive potential at electrodes at the top substrate, e.g., as shown as electrodes 13 in FIG. 4b (and a negative potential on electrodes 14), and a positive potential at electrodes at the bottom substrate, e.g., as shown as electrodes 14 in FIG. 4b, the transparency or reflectivity can be maintained, while decreasing corrosion damage to the electrodes. This alternating electric field can be achieved by applying alternating electric potentials to the top and bottom electrodes.

Applying an AC waveform is optional, but it is a useful measure to increase the lifetime of the light modulator by reducing corrosion. Corrosion can form for example, when using copper electrodes, since copper ions dissolve in an ionic fluid at one substrate and flow to electrode on the opposite substrate, where they deposit. By applying a waveform the direction of copper ion transport is frequently reversed, thus reducing corrosion damage. Between the two instances P1 and P2 the corrosion current between the two substrates is balanced or substantially, e.g., >95%, balanced, e.g., as corrosion rate of an electrode of the top plate occurs there is a balancing deposition of copper on the bottom electrode between each instance of time, P1 and vice versa in instance P2. Therefore, the particles are transitioning or migrating continuously between top and bottom electrode, and the light modulator or smart window is always in the on-state while the dynamic electrolysis current between the top and bottom electrode is constant thus there is no or a negligible net loss of electrode material on the top and bottom substrates.

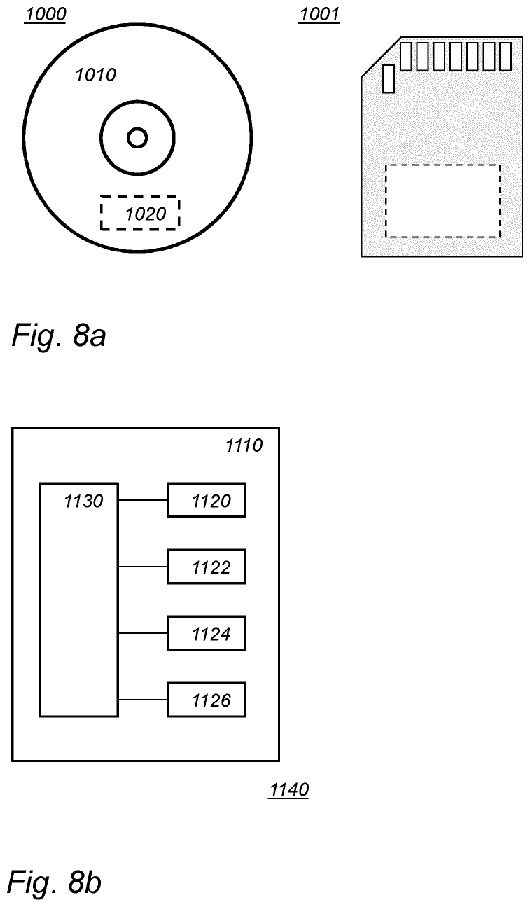

FIG. 4c shows how a state of decreased transparency or reflectivity can be obtained. An alternating voltage is applied on the same substrate. For example, in an embodiment a potential +V2 is applied to a first electrode and the next immediate neighboring electrode has an opposite potential −V2 etc., as shown in FIG. 8c. This can be obtained by applying the potential +V2 to electrode 13a and the opposite potential −V2 to electrode 13b. On the opposite substrate the potential +V2 may be applied to electrode 14a and the opposite potential −V2 to electrode 14b. For example, the electrodes may be arranged so that the electrodes on the substrates are aligned; an electrode on the top substrate having an opposite electrode on the bottom substrate, and vice versa. For example, to decrease transparency or reflectivity, the opposite electrode may receive the same potential, while neighboring electrodes receive an opposite potential. An embodiment is shown in FIG. 4c, wherein four electrodes are indicated with the reference numbers 13a, 13b, 14a and 14b, and the rest of the electrodes continue to alternate.

By using this AC drive cycle between top and bottom substrates, diagonal and lateral electric fields are generated between the two substrates thereby causing haphazard diffusion of the particles thereby creating the closed state of the light modulator. As a result of this configuration, the particles migrate diagonally and laterally between the top and bottom substrate and diffusion of particles into the visible aperture of the light modulator contributes to the closed, opaque state of the light modulator.

As for the transparent state shown in FIG. 4b, a waveform may be applied to the electrodes, e.g., so that electrodes that are shown in FIG. 4b with a positive potential become negative and vice versa. As in FIG. 4b applying a waveform, e.g., between electrodes 13a and 13b and between 14a and 14b reduces corrosion damage to the electrodes.

The AC drive cycle may be implemented by using an interdigitated line configuration combining the top and bottom electrode configuration shown in plan view in FIGS. 1a, 1b, 2a-2f, etc.

The extent with which transparency or reflectivity is increased or decreased in FIGS. 4b and 4c depends on the voltage and frequencies difference. By varying the voltage difference, the amount by which the transparency or reflectivity increases, respectively, decreases, is controlled. For example, a curve representing light transmission versus voltage may be determined, e.g., measured. To obtain a particular level of light transmission, e.g., a particular transparency, e.g., a particular grey-scale level, the corresponding voltage, e.g., AC voltage may be applied. By interpolating the signals for a transparent or for a non-transparent state, levels in between transparent and non-transparent may be obtained. Likewise, a curve representing light reflection versus voltage may be determined, e.g., measured. To obtain a particular level of reflectivity, the corresponding voltage, e.g., AC voltage may be applied. By interpolating the signals for a reflective or for a non-reflective state, levels in between reflective and non-reflective may be obtained.

Different electrode patterns may be used, for a light modulator. The electrode patterns may each provide a range of greyscales, e.g., levels of transparency or reflectivity, that the light modulator can attain. However, the particular range of greyscale for any particular electrode pattern may be different from another electrode pattern. In other words, although different patterns give an increased transparency or reflectivity or an increased opacity, the exact response to a drive signal depends on many factors, including the particular pattern that is used. The variations in the optical properties of a light modulator may have a fine resolution, e.g., below 1 mm. Note that no pixilation of the light modulator is needed to achieve different optical patterns, e.g., logos, visible in the light modulator.

This effect may be used to embed visible images in the light modulator by locally changing the electrode pattern on the substrates of a light modulator. For example, one may locally have greyscales that have a permanent off-set in greyscale relative to each other, because of a different electrode pattern. For example, by locally changing the electrode pattern or its pitch, the maximum transparency or reflectivity can be altered.

The result is an area on the light modulator which has a different intensity of greyscale, e.g., a different greyscale, or of coloring. The area may have the same color-point, though. In an embodiment, they may switch together with the rest of the window, although at a different rate. For example, even if the same voltage is applied to the electrodes in two different areas, they cause a different transparency state, e.g., different transmission level, due to different electrode patterns. For example, a curve representing transmission versus voltage may be shifted. For example, if voltage control is changed in the same way in both areas, then in both areas light transmission may change, but with a different amount. An area may also be made less response to a drive signal by reducing the density of electrodes; in particular, an area may be made not to switch at all, e.g., by not applying electrodes in the area.

For example, the electrode material may be copper, aluminum, gold, indium-tin oxide (ITO), etc. ITO is transparent while Cu/Al is reflective, thus using a different electrode material, a different appearance may be obtained, irrespective of the voltage driving. Likewise, different materials with a different resistance will give rise to a different electric field. For example, ITO will have a smaller electric field, even though driven with the same voltage.

An embodiment of a method of modulating light, comprises applying an electric potential to multiple driving electrodes applied to two opposing substrates according to an embodiment to obtain an electro-magnetic field between the multiple driving electrodes providing electrophoretic movement of the particles towards or from one of the multiple driving electrodes causing modulation of light shining through the substrates, wherein the two opposing substrates are as in an embodiment.

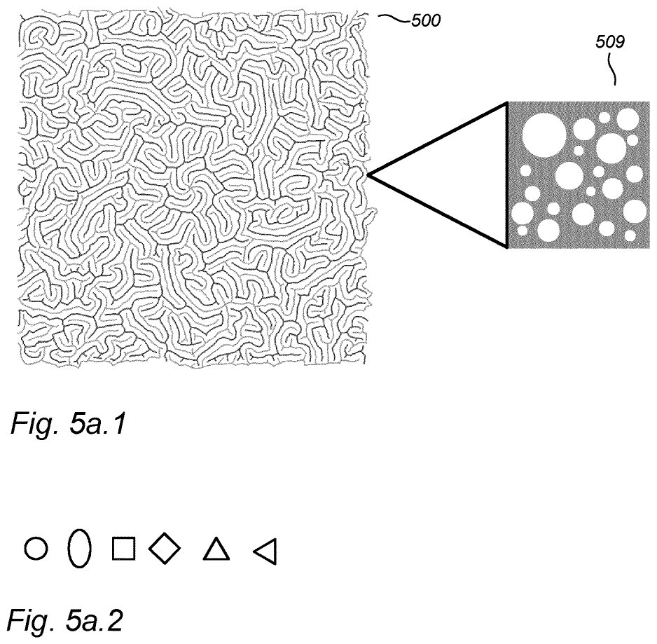

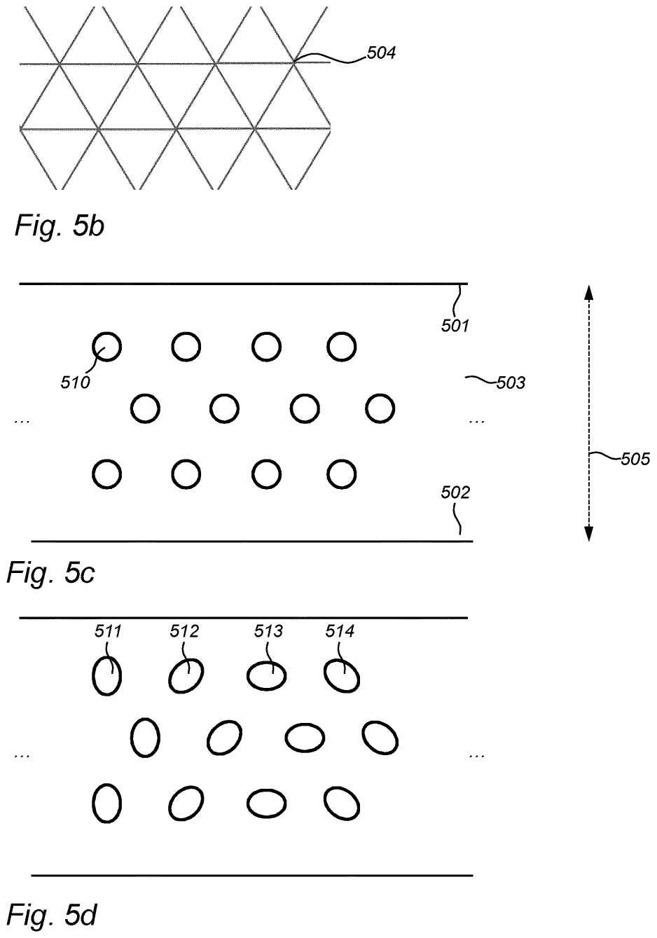

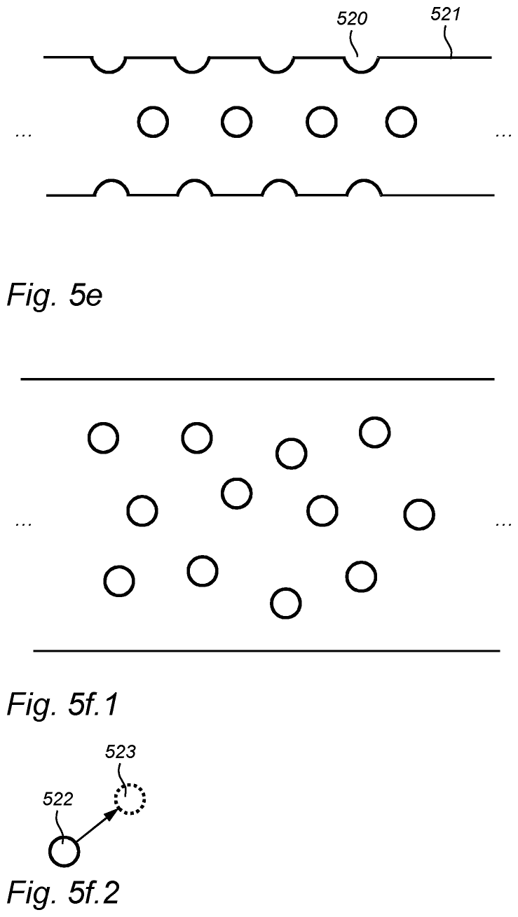

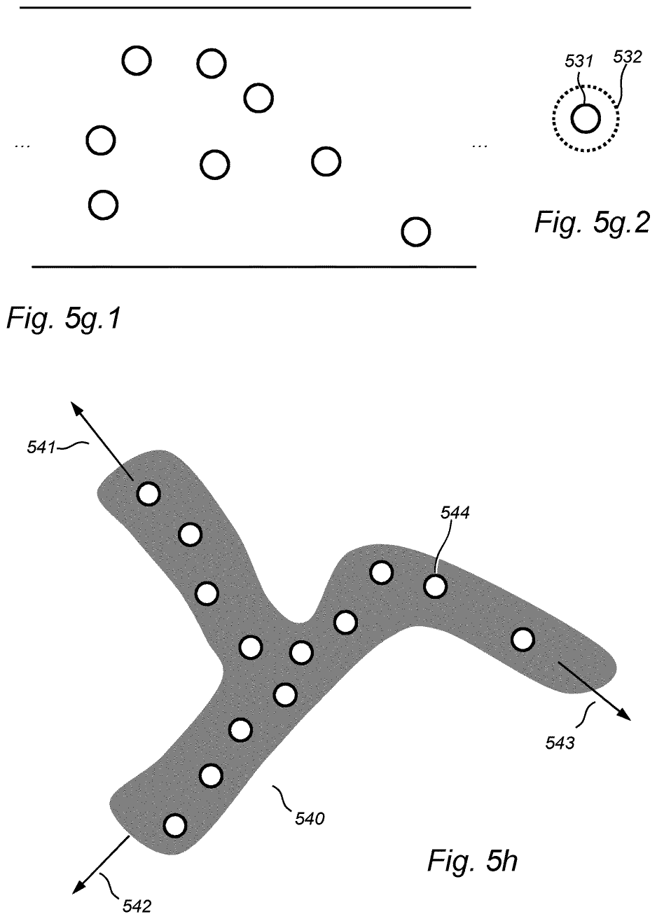

FIG. 5a.1-7b schematically show examples of an embodiment of a substrate and apertures. At least one driving electrode is applied to a side of the substrate. Typically, two interdigitated driving electrodes are applied to a side of the substrate. The driving electrodes extend in a pattern across the side of the substrate, e.g., to control local electrical field modulation. The substrates shown in the figures may be arranged in a light modulator. Typically, at least one or both of the substrates are transparent, so that at least part of the light for at least part of the visible spectrum passes through the substrate. Typically, a substrate having perforated electrodes applied to it is transparent. The same holds for other types of radiation. For example, the transmission of infrared light may be increased by applying apertures.

Likewise, the electrodes may be transparent. For example, at least one driving electrode on a substrate, or all electrodes on a substrate, or all electrodes on both opposite substrates, comprise ITO. In an embodiment, a transparent substrate has non-transparent electrodes, e.g., the electrodes may comprise a metal. The non-transparent electrodes are perforated and therefore less visible than they would be otherwise.

In particular, two substrates as shown in the figures may be arranged in a light modulator opposite to each other, with an optical layer arranged between the first and second substrates that comprises a fluid comprising particles.

Movement of the particles towards or from the driving electrode dependent upon the electro-magnetic field causing modulation of the optical properties of the light modulator. In particular, the electrophoretic effect may be used to move charged particles.

FIG. 5a.1 schematically shows an example of an embodiment of a substrate 500. Shown in FIG. 5a.1 are two interdigitated driving electrodes applied to a side of the substrate. The driving electrodes extend in a pattern across the side of the substrate.

In this case the driving electrodes comprise electrode lines that extend over the substrate. The electrode lines comprise multiple apertures. For example, an electrode line, e.g., may extend, along a longitudinal direction and along a transverse direction, said extension in the longitudinal direction being, at least at a portion of the line electrode, at least 10 times, more preferable at least 100 times, longer than the extension in the transverse direction.

The electrodes lines of the driving electrode are interdigitated with each other. For example, the electrodes lines of a first driving electrode are interdigitated with the electrodes lines of a second driving electrode. Facing edges of consecutive electrode lines having a minimum distance between them, e.g., of at least 20 micron. An electrode line extends in a length dimension and a width dimension, said width being less than 100 micron.

Shown in FIG. 5a.1 is a detail 509 of the driving electrodes. Schematically illustrated in detail 509 are multiple apertures that perforate the driving electrode, e.g., that extend through the electrode thus allowing incident radiation to pass through the first substrate and the driving electrode into the optical layer, or vice versa. Some embodiments herein are described for light, e.g., visible light, as the application, but such an embodiment can be adapted for infrared light instead.

An aperture in an electrode does not comprise electrically conducting material, but is surrounded on all sides by electrically conducting. A partial aperture is partially surrounded by electrically conducting material. In an embodiment, the one or more electrodes comprise at least 100, preferably at least 500, more preferably at least 1000 apertures.

Perforation may be applied to other electrode patterns, e.g., as shown in FIGS. 2a-2f. Perforation may be applied in various ways.

A driving electrode is typically a line electrode. A line electrode may extend, along a longitudinal direction and along a transverse direction, said extension being, at least at a local portion of the line electrode, at least 10 time, more preferable at least 100 times, longer in the longitudinal direction being than the extension in the transverse direction.

The various sizes in an embodiment of a substrate may be related to the sizes of the particles that are intended to be used. One metric for particles is the average diameter. If the particles are spherical, the diameter may be taken as twice the radius. If the particles are non-spherical, then the diameter may be defined as the least upper bound of the set of all distances between pairs of points in a particle. Aperture diameter may be defined in the same manner, e.g., the least upper bound of the set of all distances between pairs of points in the aperture. If an aperture is a disc, then this definition aligns with the definition of a diameter.

The size of an aperture, say the average aperture diameter, may be related to the sizes of the particles that are used in the optical layer. For example, the average aperture diameter may be between 5 and 50 times larger than the average particle diameter. The average line width of the driving electrode may be between 5 and 50 times larger than the average diameter of the apertures. The line width may be taken as the shortest distance from a point on an edge to a point on an opposite edge of the same electrode.

As a non-limiting illustration, for example, a driving electrode may have a line width of say in the range of 10-100 micrometer, and the width between them, the line gap, may be in the same range. For example, a minimum line gap between electrodes may be, say 20 micrometer, with an average line gap, of say of 50 micrometer. Particles may have an average diameter of at most 500 nanometer. Average aperture diameter may be at least 1 micrometer.

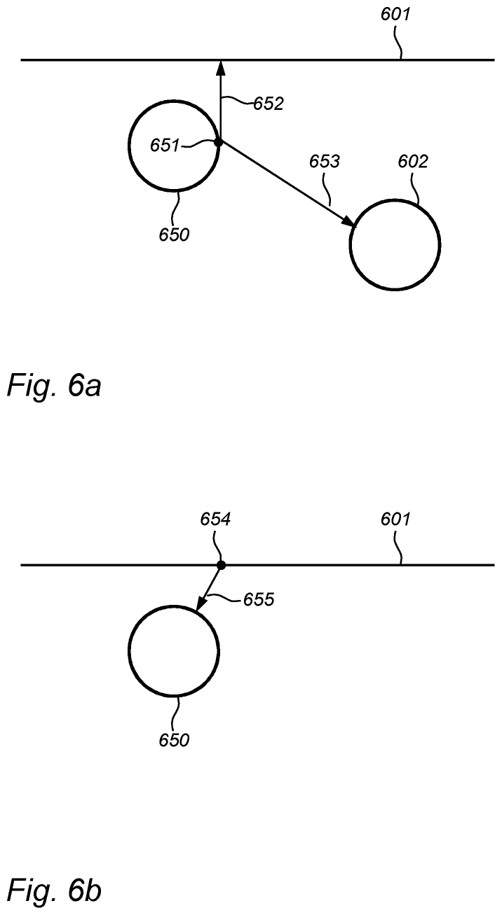

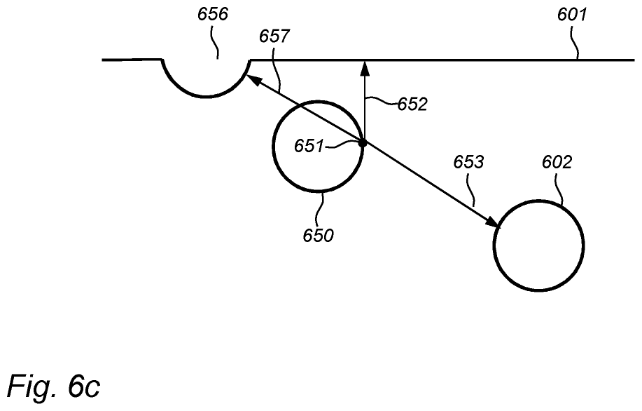

The distribution of the apertures may also depend on particle size. This is further illustrated in FIGS. 6a-6c.

Apertures may have various effects: making electrodes less visible to a user of the light modulator, reducing diffraction, increasing the effect of the electric field. The diameter of apertures may further be chosen to boost a specific wavelength range, due to the to the plasmonic effect.

In a light modulator according to an embodiment, driving electrodes may be applied to both substrates. For example, this may be the case in an electrophoretic light modulator. Typically, the driving electrodes on opposite substrates are aligned with each other; although typical, this is not actually necessary. Both electrodes on opposite substrates may be perforated, e.g., provided with apertures. If this is done, the apertures may or may not align. Non-aligned apertures have the advantage of easier manufacture, and avoid optical artefacts. Because of stray light, the transmission of the light modulator for light still increases. Moreover, the improved electric field is maintained even if one or more or all of the apertures are not aligned. For example, an aperture is not aligned if the orthogonal projection of the aperture onto the other substrate does not overlap with an aperture on the other substrate. On the other hand, apertures may align if desired. Aligned apertures have the advantage that the same design for an electrode mask can be used for both substrates, albeit typically mirrored. Instead of fully aligning, the apertures may also partially align.

Arranging apertures on the two substrate so that they do not align, or partially align, may be done by offsetting the apertures on one substrate with respect to the apertures on the other substrate. The aperture locations may also be arranged independently on the two substrates.

FIG. 5a.2 schematically shows an example of embodiments of an aperture. Many shapes are possible for an aperture. For example, apertures could be circular shaped. Circular shaped apertures are compatible with various manufacturing techniques. For example, a circular aperture may be created with a laser, or the like.

Apertures do not have to be circular, and could have various shapes. In an embodiment, the apertures are part of a mask for the electrode design. Such a mask may be used in a photolithography process to transfer the electrode design onto the substrate. For example, a stepper may be used to repeatedly apply one or more building blocks.

For example, an aperture may be elongated, e.g., an elliptic shape. For example. For example, an aperture may be a polygon. A circle has full radial symmetry. An advantage of using shape without full radial symmetry, e.g., having a finite number of radial symmetries, e.g., a shape without radial symmetry, is the possibility to randomize the design of the apertures by rotating the apertures.

Shown in FIG. 5a.2 are possible aperture shapes, these include: a circle, an ellipse, a square, a rotated square, a triangle, a rotated triangle.

Many example embodiments shown herein use a circular or ellipse aperture, but these could be modified to use another shape of aperture.

FIG. 5b schematically shows an example of an embodiment of a tessellation, or tiling. A tessellation may be used to generate regular patterns of apertures. A tessellation covers the plane, e.g., a substrate, using one or more geometric shapes, also called tiles. The number of geometric shapes may be one, or more than one. The tessellation comprises vertices and edges between the vertices. For example, a vertex may be a common point between three tiles. One vertex has been identified as vertex 504 in FIG. 5b.

At those places where an electrode intersects a vertex of the tessellation, an aperture may be placed. By changing the size of the tessellation with respect to the substrate the density of apertures in driving electrodes may be controlled.

Many tessellations are known in the art, e.g., hexagonal tiling, square tiling and so on. Tessellations may be periodic, e.g., wherein the tessellation has a subset of shapes that can be translated to cover the entire plane. An example of an aperiodic tiling is the Penrose tiling. The latter is also an example of a tiling using two different geometric shapes. Using an aperiodic pattern has the effect that the resulting aperture distribution is also aperiodic, and thus less regular. Using an aperiodic tessellation to generate aperture locations has the advantage that the aperture location will be aperiodic, yet have still have upper and lower bounds on its density, depending on the size(s) of the geometric shapes in the tessellation.

Generally speaking regular aperture distributions have the effect of better predictability of the resulting electric fields, and optical effects. Aperiodic aperture distributions have the effect of better lower diffraction.

In an embodiment, an aperture is placed at a vertex only if the aperture is fully contained in the electrode. In an embodiment, an aperture is placed at a vertex only if the aperture is at least a threshold distance away from the edge of the electrode. For example, the threshold may be at least the average diameter of the apertures.

The apertures applied at vertices of the tessellation may be of equal size, e.g., as shown below in FIG. 5c, but this is not necessary. Different sized apertures may be used instead. The sizes of the apertures may itself follow a regular, e.g., periodic, distribution, or not.

The vertices in a periodic tessellation are an example of a two-dimensional lattice. More general, a lattice may be used to determine aperture locations. To generate a lattice, a tessellation is not needed, but may instead be defined by, e.g., a lattice basis comprising multiple lattice basis vectors.

FIG. 5c schematically shows an example of an embodiment of an electrode 503. Note that detail 509 in FIG. 5a.1 and in FIG. 5h the electrode material is shaded, but this is not done in most other figures.

Shown in FIG. 5c are electrode edge 501 and electrode edge 502. The distance between the electrode edges is the line width 505, indicated schematically in FIG. 5c as a dashed line 505.

Shown in FIG. 5c are a number of apertures applied to the electrode. One of the apertures is indicated with numeral 510. The apertures allow radiation, such as light, to pass from the substrate through the electrode, and vice versa. The aperture distribution shown in FIG. 5c is periodic and regular. The aperture distribution shown in FIG. 5c was applied using the tessellation of FIG. 5b.

FIG. 5d schematically shows an example of an embodiment of an electrode. The electrode of FIG. 5d is the same as that of FIG. 5c except that instead of circular apertures, elliptic apertures are used. Although the apertures are located at the same regular positions, a rotation has been applied to the apertures. In the figure, the rotations are applied according to a regular, e.g., periodic pattern. Shown are apertures 511-514. These apertures are rotated over 0, 45, 90, and 135 degrees, respectively. This is not necessary, as the rotation applied may be random, e.g., drawn from a probability distribution.

FIG. 5e schematically shows an example of an embodiment of an electrode. The electrode of FIG. 5e is the same as that of FIG. 5c except that the line width is smaller with respect to the average aperture diameter. Moreover, no threshold is enforced between an electrode edge and an aperture. As a result, in this example, a number of apertures are only partially applied.

Electrode material, e.g., metal, e.g., copper, e.g., ITO, or the like, is sometimes removed (or not applied) in the shape of a complete aperture, in this case a circle, and sometimes only partially. One partial aperture is shown at 520. As a result the electrode edge 521 is now serrated. An advantage of serrated edges is that the length of the electrode edge increases, without a correspondingly large reduction in electrode area.

In the examples 5c-5e the tessellation is aligned with the electrode before applying the apertures. This is not necessary. For example, the tessellation may have an angle with the electrode. For example, the tessellation may be fixed with respect to the plane.

In low-diffraction electrode designs, in which the electrode directions are randomized, e.g., as in FIGS. 2f and 5a.1 it is preferred to align tessellations locally with the electrodes. This avoids creating a regular aperture distribution over the entire substrate, which may increase the diffraction. For example, a transformation may be used that maps an electrode or parts thereof to a straight line. An aperture distribution on the straight line may then be transformed back to the electrode using the inverse of the transform. The transform is preferably a diffeomorphism.

Too regular structures on a light modulator can lead to diffraction, which is generally considered a disadvantage. Especially in light modulators wherein all substrates are transparent, e.g., dynamic glazing, this can be a problem. Accordingly, there is a desire to randomize aperture distribution. Various randomization possibilities exists, and multiple may be combined. FIG. 5d shows one way to do so, e.g., by rotating apertures. The rotations may be randomized.

FIG. 5f.1 schematically shows an example of an embodiment of an electrode. The electrode of FIG. 5f.1 is the same as that of FIG. 5c except that the position of apertures is randomized. The aperture distribution of FIG. 5f.1 is regular, e.g., periodic, except that a randomized shift is applied to one or more or all of the apertures; in this case to all of the apertures. For example, FIG. 5f.2 schematically shows an example of an embodiment of a shift. An original aperture 522 is shown, e.g., according to a tessellation, and a shifted aperture 523. The shift, e.g., the vector from original aperture 522 to the shifted aperture 523 may be randomly selected. For example, the coordinates of the vector may be drawn from a random probability distribution. A probability distribution may be a uniform distribution, but other distributions are also possible, in this case for example a two-dimensional Gaussian distribution may be used.

For example, a shift may be selected for each of the apertures in turn.

FIG. 5g.1 schematically shows an example of an embodiment of an electrode. The locations for apertures in FIG. 5g.1 are selected randomly. This leads to an irregular pattern.

Regardless how an aperture distribution is randomized, e.g., using rotations, shifts, or random locations, additional constraints may be applied. For example, one or more of the following constraints may be enforced for a randomized aperture distribution, especially if location is randomized, e.g., by shifting or random generation of aperture locations.
the apertures should not partially or wholly overlap, as this may lead to fewer or larger apertures than intended,
the conductivity of the electrode should not be reduced too much, e.g., beyond a threshold, in particular, the apertures should not lead to breaking an electrode, e.g., causing part of the electrode to become isolated from another part of the electrode, or nearly so. If conductivity becomes too small, the ability of the light modulator to effectively modulate light is impaired.
the local density of the apertures across the substrate, preferably does not have too large variations, e.g., not exceeding a threshold, as this may be visible in the light modulator. This constraint may be violated intentionally, e.g., for signage. For example, local density for a region may be defined as the ratio of aperture area in the region and region area. For example, a rectangular region of 10 by 10 micrometer may be used to compute local densities across the substrate.

FIG. 5g.2 schematically shows an example of an embodiment of an aperture 531. After aperture 531 is placed an exclusion zone 532 is drawn around aperture 531, e.g., exclusion zone 532 may be the same shape but proportionally larger than aperture 531. If a next aperture were placed on the electrodes in an exclusion zone, then the placement is skipped or modified.

FIG. 5h schematically shows an example of an embodiment of an electrode 540. Shown is a detail of electrode 540. Electrode 540 is an example of an electrode that is not straight. Moreover, electrode 540 is an example of a bifurcating, e.g., splitting, electrode. For example, electrode 540 may be used in an electrode design with curved electrodes such as the design in FIG. 2f or 5a.1.

The electrode edges may be defined by a series of line segments, e.g., a polygonal chain. The electrode edges may be defined by a spline or a series of spline segments. The electrode 540 continues into three directions, e.g., direction 541-543. Randomly placed apertures are added to the electrode subject to constraints, e.g., a minimal distance between aperture edges and electrode edges, and a lower bound on aperture density to ensure sufficient conductivity. One aperture is marked with numeral 544.

If a randomized placement would violate a constraint, a new randomization may be selected. For example, an algorithm may be as follows
1. obtain an electrode pattern for a substrate
2. select a random location for an aperture
3. verify if constraints are met, if not skip the selected location, otherwise place the constraint.
4. Verify if a stop criterion is met, e.g., no more progress in aperture placement, e.g., exceeded maximum number of aperture, e.g., exceeded maximum run time, or some combination. If not continue at step 2.

Regardless of the placement method, a minimum distance may be enforced between two points on different aperture edges or electrode edges on the same electrode. This will also imply a lower bound on the density of apertures. The minimum distance may depend on the average diameter of the particles. For example, minimum distance may be at least twice the average diameter of the particles.

FIG. 6a schematically shows an example of an embodiment of an electrode. Only the top electrode edge 601 is shown in the figure. Shown in FIG. 6a are two apertures 650 and 602. In the configuration of FIG. 6a the constraint is enforced that the minimal distance for any two point on different edges, e.g., aperture or electrode edges, on the same electrode should be larger than a minimal threshold, e.g., twice the average particle size.

For example, given a point 651 on the edge of aperture 650. The distance between point 651 any point on electrode edge 601 should be larger than the threshold. In particular, the closest point on edge 601 should have a larger distance. The closest point and distance is indicated with vector 652.

For example, given a point 651 on the edge of aperture 650. The distance between point 651 any point on aperture edge 602 should be larger than the threshold. In particular, the closest point on edge 602 should have a larger distance. The closest point and distance is indicated with vector 653.

So the length of vectors 652 and 653 should be above the threshold to satisfy the constraint for point 651.

FIG. 6b schematically shows an example of an embodiment of an electrode. In FIG. 6b only the top electrode edge 601 and one aperture 650 is shown. Given a point 654 an electrode edge. The distance between point 654 and any point on aperture edge 650 should be larger than the threshold. In particular, the closest point on edge 650 should have a larger distance. The closest point and distance is indicated with vector 655.

In an embodiment, a minimum distance between two points on different aperture edges on the same electrode, between a point on an aperture edge and an electrode edge, is at least 300 nanometer, or at least 700 nanometer. This condition is especially advantageous if the radiation permissibility improvement is aimed at light, that is visible light, since the wavelength of visible light runs from 380 nm to 700 nm.

A complication can arise with partial apertures, e.g., serrated electrode edges. FIG. 6c schematically shows an example of an embodiment of an electrode. FIG. 6c corresponds to FIG. 6a but with an additional serration 656, e.g., a partial aperture crossing an electrode edge. In addition to the distances shown in FIG. 6a, FIG. 6c also shows the nearest distance to the serration, indicated with vector 657. Note that for the serration only the points are taken into account that are part of the electrode edge, not the part of the aperture that does not correspond to removed or unapplied electrode material.

Computing distances to enforce these types of constraints may be done in a O(n²) algorithm by considering each pair of n points to verify the distance constraint. A linear algorithm that may be applied to efficiently compute distance between sets of points in the article “Distance Transforms of Sampled Functions” by Pedro F. Felzenszwalb, and Daniel P. Huttenlocher.

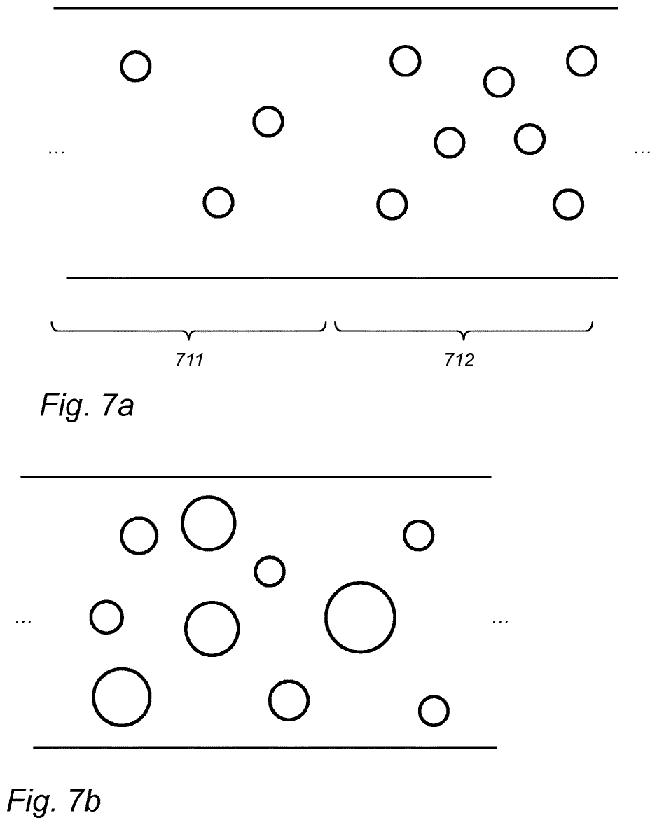

FIG. 7a schematically shows an example of an embodiment of an electrode, having a low density region 711 and a high density region 712. The number of apertures per area of the electrode, or the area of aperture per area of electrode is lower in the region 711 than in region 712. Such differences may be visible to the naked eye. For example, transitions in region 712 may be faster due to a more efficient electric field. Furthermore, the density of aperture may also be directly visible, especially with the right lighting. Not shown in FIG. 7a, but there may also be regions, e.g., without apertures. Whereas often a uniform appearance of a light modulator is desired, this is not necessary, and may even be exploited. A pattern of aperture density, e.g., a pattern of higher and lower density regions may form a visible image. The image may be used for any reason, e.g., to show signage.

FIG. 7b schematically shows an example of an embodiment of an electrode. FIG. 7b shows a random placement. Here also the size of apertures, e.g., its diameters, have been randomized. In this case, by enlarging and shrinking apertures. Allowing different sizes makes it easier to satisfy a density constraint that have lower and upper bounds. Allowing smaller apertures between the larger apertures makes it easier to increase aperture density while still satisfying minimum distance constraints.

An aperture distribution could also be obtained by randomizing a regular aperture distribution, e.g., the one of FIG. 5c. The randomization may involve shifting of apertures, and resizing of apertures.

Aperture diameters may be randomly selected, e.g., from a continuous scale, but may also be selected from a discrete set of diameters.

The following list of numbered clauses are examples that have each been contemplated. They are examples of embodiments.

### Light Modulator

Clause 1. A light modulator comprising:
   a first substrate and a second substrate, the first substrate and the second substrate being arranged with inner sides opposite to each other, the first substrate being transparent, at least one driving electrode being applied to the inner side of the first substrate, the driving electrode extending in a pattern across the inner side of the first substrate,
   an optical layer arranged between the first substrate and second substrate that comprises a fluid comprising particles,
   a controller configured to apply an electric potential to the at least one driving electrode to obtain an electro-magnetic field providing movement of the particles towards or from the driving electrode causing modulation of the optical properties of the light modulator, wherein
   the driving electrode comprises multiple apertures extending through the electrode thus allowing incident radiation, such as light, to pass through the first substrate and the driving electrode into the optical layer, or vice versa.
Clause 1.1. A light modulator as in clause 1 wherein the apertures are circular.
Clause 2. A light modulator as in clause 1,
   wherein an average aperture diameter is at least two times the average particle diameter,
   more preferably, wherein the average diameter of the apertures is between 5 and 50 times larger than the average diameter of the particles.
Clause 3. A light modulator as in any one of the preceding clauses, wherein a minimum distance between two points on different aperture edges or electrode edges on the same electrode is at least two times the average diameter of the particles.
Clause 4. A light modulator as in any one of the preceding clauses, wherein the multiple apertures have multiple different diameters.
Clause 5. A light modulator as in any one of the preceding clauses, wherein an average line width of the driving electrode is between 5 and 50 times larger than the average diameter of the apertures.
Clause 5.1. A light modulator as in any one of the preceding clauses, wherein the apertures are distributed across the driving electrode in varying density.
Clause 5.2. A light modulator as in any one of the preceding clauses, wherein part of the driving electrode does not comprise apertures.
Clause 6. A light modulator as in any one of the preceding clauses, wherein the multiple apertures are distributed randomly across at least part of the electrode.
Clause 7. A light modulator as in any one of the preceding clauses, wherein at least one driving electrode comprises an ITO electrode.
Clause 8. A light modulator as in any one of the preceding clauses, wherein at least one driving electrode is applied to the inner side of the second substrate, the driving electrode extending in a pattern across the inner side of the second substrate, the controller being configured to apply an electric potential to the at least one driving electrode on the first substrate and second substrate, wherein the driving electrode on the second substrate comprises multiple apertures extending through the electrode thus allowing incident radiation, such as light, to pass through the second substrate and the driving electrode into the optical layer, or vice versa.
Clause 9. A light modulator as in Clause 8, wherein the one or more driving electrodes on the first substrate are aligned with the one or more electrodes on the second substrate, but wherein
   the apertures in the one or more driving electrodes of the first and second substrate do not align, and/or
   at least part of the apertures in the one or more driving electrodes of the first and second substrate partially align, and/or
   the apertures in the one or more driving electrodes of the first and second substrate are offset with respect to each other.
Clause 10. A light modulator according to any one of the preceding clauses, wherein the particles are electrically charged or chargeable, and the controller is configured to apply an electric potential to the driving electrode to obtain an electro-magnetic field providing electrophoretic movement of the particles towards or the driving electrode causing modulation of the optical properties of the light modulator.
Clause 10.1. A light modulator as in Clause 10, wherein multiple interdigitated driving electrodes are arranged across each of the first and second substrate's inner side, and a controller configured to apply an electric signal to the multiple electrodes to obtain an electric field between the multiple electrodes providing electrophoretic movement of the particles causing the modulation of the optical properties of the light modulator.
Clause 10.2 A light modulator as in any one of Clauses 10-10.1, the light modulator being configured to
   switch to the non-transparent state by creating an alternating voltage on at least one of the first second substrate and second substrate, applying an alternating current between at least a first electrode and a second electrode on the first substrate and/or between a first electrode and a second electrode on the second substrate,
   switch to the transparent state by creating an alternating voltage between the first and second substrate, applying an alternating current between a first electrode on the first substrate and a first electrode on the second substrate, and/or between a second electrode on the first substrate and a second electrode on the second substrate.
Clause 10.3 A light modulator as in Clauses 10-10.2, wherein the electric signal is an AC signal.
Clause 10.4 A light modulator according to any one of the preceding clauses, wherein the particles are charged or chargeable, wherein particles are moved due to an electrophoretic force.
Clause 11. A light modulator according to any one of the preceding clauses, wherein the apertures have a specific diameter to boost a specific wavelength range.
Clause 12. A light modulator according to any one of the preceding clauses, wherein the particles are charged or chargeable, wherein particles are moved due to an electrophoretic force.
Clause 13. A light modulator according to any one of the preceding clauses, wherein the driving electrode is a line electrode, e.g., wherein the line electrode extends, along a longitudinal direction and along a transverse direction, said extension being, at least at a local portion of the line electrode, at least 10 time, more preferable at least 100 times, longer in the longitudinal direction being than the extension in the transverse direction.
Clause 15. A light modulator according to any one of the preceding clauses, having
   a transparent state and a non-transparent state, and/or
   a reflective state and a non-reflective state,
      the light modulator being configured to switch between states by modulating a current between the one or more driving electrodes applied on the first substrate and optionally one or more driving electrodes applied on the second substrate.
Clause 16. A light modulator according to any one of the preceding clauses, wherein
   an electric signal is provided as an alternating current (AC) in the one or more electrodes, or
   an electric signal is provided as a direct current (DC) in the one or more electrodes, wherein the voltage is periodically reversed.
Clause 16. A light modulator as in any one of the preceding clauses, wherein the first substrate and the second substrate are transparent.
Clause 17. A light modulator as in any one of the preceding clauses, wherein one of the first substrate and the second substrate is transparent and one of the first and second substrates is reflective or partially reflective.
Clause 18. A light modulator as in any one of the preceding clauses, wherein the one or more electrodes comprise multiple interlaced mesh electrodes,
   multiple interlaced mesh electrodes extending in a two-dimensional pattern across the first substrate and across the second substrate, two mesh electrodes of the multiple mesh electrodes on a substrate crossing at a plurality of crossing points spread across the substrate.
Clause 19. A light modulator as in any one of the preceding clauses, wherein
   the particles are nanoparticles and/or microparticles, and/or
   the particles are adapted to absorb light,
   the particles are pigment particles.
Clause 20. A light modulator as in any one of the preceding clauses, wherein the at least two electrodes comprise an electrically conducting material with a resistivity of less than 100 nΩm at 273 K,
Clause 21. A light modulator as in any one of the preceding clauses, wherein the electrodes are in fluidic contact with the fluid or wherein the electrodes are separated from the fluid, e.g., by a coating.
Clause 22. A light modulator as in any one of the preceding clauses, wherein electrodes applied to a substrate cover 1-30% of a substrate surface.
Clause 23. A light modulator as in any one of the preceding clauses, wherein the electric potential is operated at an AC frequency of 10-100 Hz for switching to a transparent state, and/or is operated at an AC frequency of less than 1 Hz for switching to a non-transparent state.
Clause 23. A light modulator as in any one of the preceding clauses, wherein a size of the nanoparticles is from 10-1000 nm, preferably from 100-500 nm.
Clause 24. A light modulator as in any one of the preceding clauses, wherein the particles are adapted to absorb light with a wavelength of 10 nm-1 micron.
Clause 25. A light modulator as in any one of the preceding clauses, wherein a distance between the first and second substrates is smaller than 500 μm.
Clause 26. A light modulator as in any one of the preceding clauses, wherein a dynamic viscosity of the fluid is 500 mPa.s or less.
Clause 27. A light modulator as in any one of the preceding clauses, wherein the fluid has a relative permittivity Er of less than 100.

### Method

Clause 28. A method of modulating light, comprising
   applying an electric potential to one or more driving electrodes applied to one or two opposing substrates to obtain an electro-magnetic field between the driving electrodes providing electrophoretic movement of the particles towards or from one of the multiple driving electrodes causing modulation of light shining through the substrates, wherein the at least one or both of the two opposing substrates are as in any one of the preceding Clauses.
Clause 29. A method of modulating light, according to clause 28, comprising using an alternating current having two phases with an electrical potential between −220 V and +220 V, and an electrical current between −100 μA and +100 μA.
Clause 30. A transitory or non-transitory computer readable medium comprising data representing instructions, which, when executed by a processor system, cause the processor system to perform the method according to clause 28 or 29.
Clause 30. A method of manufacturing a substrate, comprising
   providing a substrate for use in a light modulator, the substrate being transparent
   applying at least one driving electrode to a side of the substrate, the driving electrode extending in a pattern across the side of the substrate, the driving electrode comprises multiple apertures extending through the electrode thus allowing incident radiation, such as light, to pass through the substrate and the driving electrode, or vice versa.

### Substrates

Clause 31. A substrate as in any one of the preceding clauses.
Clause 32. A substrate for use in a light modulator, the substrate being transparent, at least one driving electrode being applied to a side of the substrate, the driving electrode extending in a pattern across the side of the substrate, the driving electrode comprises multiple apertures extending through the electrode thus allowing incident light to pass through the substrate and the driving electrode, or vice versa.
Clause 33. A substrate for use in a light modulator, as in Clause 32, wherein the pattern of the driving electrode across the substrate comprising multiple repeated building blocks
Clause 34. A substrate as in any one of the preceding clauses, wherein
   a building block repeats across the substrate in at least two directions, and/or
   multiple different building blocks repeat across the substrate in one or two directions.
Clause 35. A substrate as in any one of the preceding clauses, wherein at least one driving bus is arranged on the substrate for each driving electrode of the at least one driving electrode to drive the driving electrode, wherein
   at least one driving bus is arranged at a side of the substrate for each driving electrode to drive the driving electrode, and/or
   the driving busses are only arranged at the side of the substrate, and/or
   the driving busses are arranged between the building blocks covering the substrate.
Clause 36. A substrate as in any one of the preceding clauses, wherein the substrate is non-rectangular.
Clause 37. A substrate for use in a light modulator as any one of the preceding clauses, wherein the at least one driving electrode comprises multiple driving electrodes,
   the multiple driving electrodes (111-114, 121-124) being interdigitated, each of the multiple driving electrodes being arranged in a pattern across the substrate, the multiple interdigitated driving electrodes being arranged alternatingly with respect to each other on the substrate, the pattern of multiple driving electrodes across the substrate comprising multiple repeated building blocks.
Clause 38. A substrate for use in a light modulator as in Clause 37, wherein the building block comprises
   the multiple interdigitated electrodes extending in at least 2 directions across the building block, the interdigitated electrodes in the building block forming the driving electrodes, for at least one electrode in the multiple interdigitated electrodes in the building block a maximal length between any two points on said electrode measured along said electrode in the building block is at least 2 times the length of the diagonal of the building block unit.
Clause 39. A substrate for use in a light modulator as any one of the preceding clauses, wherein the at least one driving electrode comprises multiple driving electrodes, wherein
   from any point in the substrate, a nearest distance to a first and to a second driving electrode is below a threshold, and/or
   from any point in the substrate, the sum of the nearest distance to the first and to the second driving electrode is below a first threshold, and/or above a second threshold, and/or
   a distance from a point on a first driving electrode to a point on a second driving electrode is at least a second threshold, and/or
   a horizontal and/or vertical size of the building block is at least 10 times the sum of an electrode line width and an electrode distance.

FIG. 8a shows a computer readable medium 1000 having a writable part 1010 comprising a computer program 1020, and a computer readable medium 1001 also having a writable part comprising a computer program. The computer program 1020 comprises instructions for causing a processor system to operate a light modulator, according to an embodiment. For example, a processor system may be connected to a light modulator panel. The computer program 1020 may be embodied on the computer readable medium 1000 as physical marks or by magnetization of the computer readable medium 1000. However, any other suitable embodiment is conceivable as well. Furthermore, it will be appreciated that, although the computer readable medium 1000 is shown here as an optical disc, the computer readable medium 1000 may be any suitable computer readable medium, such as a hard disk, solid state memory, flash memory, etc., and may be non-recordable or recordable. The computer program 1020 comprises instructions for causing a processor system to perform said light modulator method.

FIG. 8b shows in a schematic representation of a processor system 1140 according to an embodiment of a controller for a light modulator. The processor system comprises one or more integrated circuits 1110. The architecture of the one or more integrated circuits 1110 is schematically shown in FIG. 8b. Circuit 1110 comprises a processing unit 1120, e.g., a CPU, for running computer program components to execute a method according to an embodiment and/or implement its modules or units. Circuit 1110 comprises a memory 1122 for storing programming code, data, etc. Part of memory 1122 may be read-only. Circuit 1110 may comprise a communication element 1126, e.g., an antenna, connectors or both, and the like. Circuit 1110 may comprise a dedicated integrated circuit 1124 for performing part or all of the processing defined in the method. Processor 1120, memory 1122, dedicated IC 1124 and communication element 1126 may be connected to each other via an interconnect 1130, say a bus. The processor system 1110 may be arranged for contact and/or contact-less communication, using an antenna and/or connectors, respectively.

For example, in an embodiment, processor system 1140, e.g., the device may comprise a processor circuit and a memory circuit, the processor being arranged to execute software stored in the memory circuit. For example, the processor circuit may be an Intel Core i7 processor, ARM Cortex-R8, etc. In an embodiment, the processor circuit may be an ARM Cortex M0. The memory circuit may be an ROM circuit, or a non-volatile memory, e.g., a flash memory. The memory circuit may be a volatile memory, e.g., an SRAM memory. In the latter case, the device may comprise a non-volatile software interface, e.g., a hard drive, a network interface, etc., arranged for providing the software.

A controller for a light modulator, e.g., to control voltages applied to electrodes may comprise a processor circuit, but may also or instead comprise a state machine.

It should be noted that the above-mentioned embodiments illustrate rather than limit the presently disclosed subject matter, and that those skilled in the art will be able to design many alternative embodiments.

In the claims, any reference signs placed between parentheses shall not be construed as limiting the claim. Use of the verb ‘comprise’ and its conjugations does not exclude the presence of elements or steps other than those stated in a claim. The article ‘a’ or ‘an’ preceding an element does not exclude the presence of a plurality of such elements. Expressions such as “at least one of” when preceding a list of elements represent a selection of all or of any subset of elements from the list. For example, the expression, “at least one of A, B, and C” should be understood as including only A, only B, only C, both A and B, both A and C, both B and C, or all of A, B, and C. The presently disclosed subject matter may be implemented by hardware comprising several distinct elements, and by a suitably programmed computer. In the device claim enumerating several parts, several of these parts may be embodied by one and the same item of hardware. The mere fact that certain measures are recited in mutually different dependent claims does not indicate that a combination of these measures cannot be used to advantage.

In the claims references in parentheses refer to reference signs in drawings of exemplifying embodiments or to formulas of embodiments, thus increasing the intelligibility of the claim. These references shall not be construed as limiting the claim.

1. A light modulator comprising:
a first substrate and a second substrate, the first substrate and the second substrates being arranged with inner sides opposite to each other, at least one patterned driving electrode being applied to the inner side of the first substrate, the driving electrode extending in a pattern across the inner side of the first substrate,
an optical layer arranged between the first and second substrates that comprises a fluid comprising particles,
a controller configured to apply an electric potential to the at least one driving electrode to obtain an electro-magnetic field providing movement of the particles towards or from the driving electrode causing modulation of the optical properties of the light modulator, wherein
the driving electrode comprises multiple apertures extending through the electrode thus allowing incident radiation to pass through the first substrate and the driving electrode into the optical layer, or vice versa,
wherein at least one driving electrode is applied to the inner side of the second substrate, the driving electrode extending in a pattern across the inner side of the second substrate, the controller being configured to apply an electric potential to the at least one driving electrode on the first and second substrates, wherein the driving electrode on the second substrate comprises multiple apertures extending through the electrode thus allowing incident radiation to pass through the second substrate and the driving electrode into the optical layer, or vice versa.

2. The light modulator as in claim 1, wherein
the incident radiation comprises infrared radiation, and/or
the incident radiation comprises visible light.

3. The light modulator as in claim 1, wherein
an average aperture diameter is at least two times the average particle diameter, more preferably, the average diameter of the apertures is between 5 and 50 times larger than the average diameter of the particles, and/or
an average aperture diameter is less than an average width of the driving electrode, more preferably, wherein an average width of the driving electrode is between 5 and 50 times larger than the average diameter of the apertures, and/or
a combined area of the multiple apertures is less than a combined area of the driving electrode, excluding the apertures, more preferably, the combined aperture area is less than 50% of the combined driving electrode area, and/or
the multiple apertures have multiple different diameters, and/or
a minimum distance between two points on different aperture edges or electrode edges on the same electrode is at least two times the average diameter of the particles, and/or
a minimum distance between two points on different aperture edges or electrode edges on the same electrode is at least 300 nanometer, or at least 700 nanometer.

4. The light modulator as in claim 1, wherein the driving electrode comprises electrode lines that comprise multiple apertures,
facing edges of consecutive electrode lines having a minimum distance between them of at least 20 micron, preferably at least 10 micron, and/or
the electrode lines extending in a length dimension and a width dimension, said width being at most 10 cm, preferably at most 1 mm, preferably at most 100 micron, preferably at most 1 micron.

5. The light modulator as in claim 1, wherein the driving electrode comprises a mesh electrode.

6. The light modulator as in claim 1, wherein a driving bus is applied to the first substrate, configured to deliver power from an edge of the substrate to the driving electrode, the driving bus not having apertures applied to it.

7. The light modulator as in claim 1, wherein the multiple apertures are distributed randomly across at least part of the electrode.

8. The light modulator as in claim 1, wherein the at least one driving electrode comprises an ITO electrode.

9. (canceled)

10. The light modulator as in claim 1, wherein the one or more driving electrodes on the first substrate are aligned with the one or more electrodes on the second substrate, but wherein
the apertures in the one or more driving electrodes of the first and second substrate do not align, and/or
at least part of the apertures in the one or more driving electrodes of the first and second substrate at least partially align, and/or
the apertures in the one or more driving electrodes of the first and second substrate are offset with respect to each other.

11. The light modulator according to claim 1, wherein the particles are electrically charged or chargeable, and the controller is configured to apply an electric potential to the one or more driving electrodes to obtain an electro-magnetic field providing electrophoretic movement of the particles towards or from the driving electrode causing modulation of the optical properties of the light modulator.

12. The light modulator according to claim 1, wherein the apertures have a specific diameter to boost transmittance in a specific wavelength range.

13-15. (canceled)

16. A light modulator comprising:
a first substrate and a second substrate, the first substrate and the second substrate being arranged with inner sides opposite to each other, at least one patterned driving electrode being applied to the inner side of the first substrate, the driving electrode extending in a pattern across the inner side of the first substrate,
an optical layer arranged between the first and second substrates that comprises a fluid comprising particles,
a controller configured to apply an electric potential to the at least one driving electrode to obtain an electro-magnetic field providing movement of the particles towards or from the driving electrode causing modulation of the optical properties of the light modulator, wherein
the driving electrode comprises multiple apertures extending through the electrode thus allowing incident radiation to pass through the first substrate and the driving electrode into the optical layer, or vice versa,
wherein the at least one driving electrode comprises an ITO electrode.
